(19) United States
(12) Patent Application Publication
(10) Pub. No.: US 2025/0110417 A1
(43) Pub. Date: Apr. 3, 2025

(54) IMAGE FORMING APPARATUS

(71) Applicant: KYOCERA Document Solutions Inc., Osaka (JP)

(72) Inventors: Tamotsu SHIMIZU, Osaka (JP); Akira MATAYOSHI, Osaka (JP); Norio KUBO, Osaka (JP); Asami SASAKI, Osaka (JP); Kazuaki FUJIWARA, Osaka (JP); Einosuke KIKUCHI, Osaka (JP)

(73) Assignee: KYOCERA Document Solutions Inc., Osaka (JP)

(21) Appl. No.: 18/893,376

(22) Filed: Sep. 23, 2024

(30) Foreign Application Priority Data
Sep. 28, 2023 (JP) 2023-167814

(51) Int. Cl. G03G 9/093; G03G 5/082; G03G 9/113; G03G 15/08; G03G 15/16

(52) U.S. Cl. CPC G03G 9/09342; G03G 5/08221; G03G 9/1139; G03G 15/0865; G03G 15/162

(57) ABSTRACT

An image forming apparatus includes a two-component developer, a photosensitive member, a charging device, a development device and an intermediate transfer belt. The intermediate transfer belt contains a base resin and a conductive agent. The base resin includes a thermoplastic resin or a thermosetting resin. The photosensitive member includes a base member and an amorphous silicon photosensitive layer. The arithmetic average roughness Ra of the surface of the photosensitive member is equal to or greater than 37 nm but equal to or less than 105 nm. The toner particle includes a toner base particle and a toner external additive that is adhered to the surface of the toner base particle. The toner external additive includes a spacer particle. The number average primary particle diameter of the spacer particle is greater than the arithmetic average roughness Ra of the surface of the photosensitive member.

### INCORPORATION BY REFERENCE

This application is based upon and claims the benefit of priority from the corresponding Japanese Patent Application No. 2023-167814, filed on Sep. 28, 2023, the entire contents of which are incorporated herein by reference.

### BACKGROUND

The present disclosure relates to image forming apparatuses.

In an electrophotographic method, for example, a two-component developer is used which includes a carrier containing carrier particles and a toner containing toner particles. Image forming apparatuses are required to be able to suppress the generation of white spots (phenomenon in which parts of an image are left blank) and to suppress the contamination of a charging device and a photosensitive member.

### SUMMARY

An image forming apparatus according to the present disclosure includes a two-component developer, a photosensitive member, a charging device, a development device and an intermediate transfer belt. The two-component developer includes a carrier and a toner. The charging device charges the surface of the photosensitive member. The development device supplies the toner to the surface of the photosensitive member and develops the toner as a toner image. The toner image is intermediately transferred to the intermediate transfer belt. The intermediate transfer belt contains a base resin and a conductive agent. The base resin includes a thermoplastic resin or a thermosetting resin. The photosensitive member includes a base member and an amorphous silicon photosensitive layer. The arithmetic average roughness Ra of the surface of the photosensitive member is equal to or greater than 37 nm but equal to or less than 105 nm. The carrier includes a carrier particle. The toner includes a toner particle. The toner particle includes a toner base particle and a toner external additive that is adhered to the surface of the toner base particle. The toner external additive includes a spacer particle. The number average primary particle diameter of the spacer particle is greater than the arithmetic average roughness Ra of the surface of the photosensitive member.

Further features of the present disclosure and specific advantages obtained by the present disclosure will become clearer from the following description of an embodiment.

### BRIEF DESCRIPTION OF THE DRAWINGS

FIG. 1 is a diagram showing an example of an image forming apparatus;

FIG. 2 is a diagram showing an example of a photosensitive member;

FIG. 3 is a diagram showing an example of a state where a toner image is transferred to an intermediate transfer belt made of resin included in a known image forming apparatus;

FIG. 4 is a diagram showing an example of a state where the toner image is transferred to an intermediate transfer belt made of rubber included in the known image forming apparatus;

FIG. 5 is a diagram showing an example of a development device;

FIG. 6 is a diagram showing an example of a carrier particle included in a two-component developer;

FIG. 7 is a diagram showing an example of a toner particle included in the two-component developer; and

FIG. 8 is a diagram showing a measuring device which measures the image density of the toner image on the intermediate transfer belt.

### DETAILED DESCRIPTION

A problem in conventional techniques will first be described before an embodiment of the present disclosure will be described below.

For example, white spots are derived from carrier development (phenomenon in which when a toner image is developed on a photosensitive member, a carrier is adhered to the photosensitive member together with a toner). Hence, as one of the conventional techniques, an image forming apparatus is proposed which includes a carrier collection roller for collecting the carrier adhered to the photosensitive member in order to suppress the carrier development.

However, the conventional image forming apparatus described above is not practical because its size is easily increased, and cannot sufficiently suppress white spots. The conventional image forming apparatus also cannot sufficiently suppress the contamination of a charging device and the photosensitive member.

In view of the foregoing problem, an object of the present disclosure is to provide an image forming apparatus which can suppress the generation of white spots and the contamination of a charging device and a photosensitive member.

A preferred embodiment of the present disclosure will be described below. A carrier is an aggregate (for example, powder) of carrier particles. A toner is an aggregate (for example, powder) of toner particles. An external additive (each of a toner external additive and a carrier external additive) is an aggregate (for example, powder) of external additive particles. Each of the results of evaluations (values indicating shapes, physical properties and the like) on powder (more specifically, such as the powder of the toner particles, the powder of the external additive particles, magnetic powder or the powder of the carrier particles) is the number average of values obtained by performing a measurement on each of a considerable number of particles selected from the powder unless otherwise specified.

Unless otherwise specified, the measured value of the volume median diameter (D₅₀) of the powder is a value obtained by performing a measurement using a laser diffraction/scattering particle size distribution measuring device (for example, “LA-920V2” made by HORIBA, Ltd. or “Coulter Counter Multisizer 3” made by Beckman Coulter, Inc.).

Unless otherwise specified, the number average primary particle diameter of the powder is the number average value of the circle-equivalent diameters (Heywood diameter: the diameter of a circle having the same area as the projected area of a primary particle) of primary particles measured using a scanning electron microscope. The number average primary particle diameter of the powder is, for example, the number average value of the circle-equivalent diameters of 100 primary particles. Unless otherwise specified, the number average primary particle diameter of particles indicates the number average primary particle diameter of particles in the powder.

Unless otherwise specified, chargeability means chargeability in frictional charging. For example, a standard carrier provided by the Imaging Society of Japan (standard carrier for negatively charged toner: N-01, standard carrier for positively charged toner: P-01) is mixed and stirred with a measurement target (for example, a toner) to cause the measurement target to be frictionally charged. The amount of charging in the measurement target is measured before and after frictional charging, for example with a small suction-type charging amount measuring device (“Model 212HS” made by Trek Inc.), and the measurement target which has a larger change in the amount of charging before and after frictional charging indicates higher chargeability.

Unless otherwise specified, the “main component” of a material means the component in which the amount of component contained in the material is the largest in terms of mass.

A “coverage ratio” is measured by a method described in Example or a method in accordance therewith. The arithmetic average roughness Ra of the surface of a photosensitive member is measured by a method according to JIS (Japanese Industrial Standards) B0601: 2013 (Geometrical Product Specifications (GPS)—Surface Texture: Profile Method—Terms, Definitions And Surface Texture Parameters).

In the following description, a compound and its derivative may be collectively referred to by adding the term “-based” to the end of the name of the compound. When the name of a polymer is expressed by adding “-based” to the end of the name of a compound, it means that the repeating unit of the polymer is derived from the compound or its derivative. Acrylic and methacrylic may be collectively referred to as “(meth)acrylic”. Unless otherwise specified, each of components described below may be used alone or in a combination of two or more thereof.

### <Image Forming Apparatus>

The embodiment of the present disclosure relates to an image forming apparatus. The image forming apparatus of the present embodiment includes: a two-component developer that includes a carrier and a toner; a photosensitive member; a charging device that charges the surface of the photosensitive member; a development device that supplies the toner to the surface of the photosensitive member and develops the toner as a toner image; and an intermediate transfer belt to which the toner image is intermediately transferred. The intermediate transfer belt contains a base resin and a conductive agent. The base resin includes a thermoplastic resin or a thermosetting resin. The photosensitive member includes a base member and an amorphous silicon photosensitive layer. The arithmetic average roughness Ra of the surface of the photosensitive member is equal to or greater than 37 nm but equal to or less than 105 nm. The carrier includes a carrier particle. The toner includes a toner particle. The toner particle includes a toner base particle and a toner external additive that is adhered to the surface of the toner base particle. The toner external additive includes a spacer particle. The number average primary particle diameter of the spacer particles is greater than the arithmetic average roughness Ra of the surface of the photosensitive member.

In the two-component developer, for example, the carrier and the toner are stirred in the development device, and thus the toner is charged.

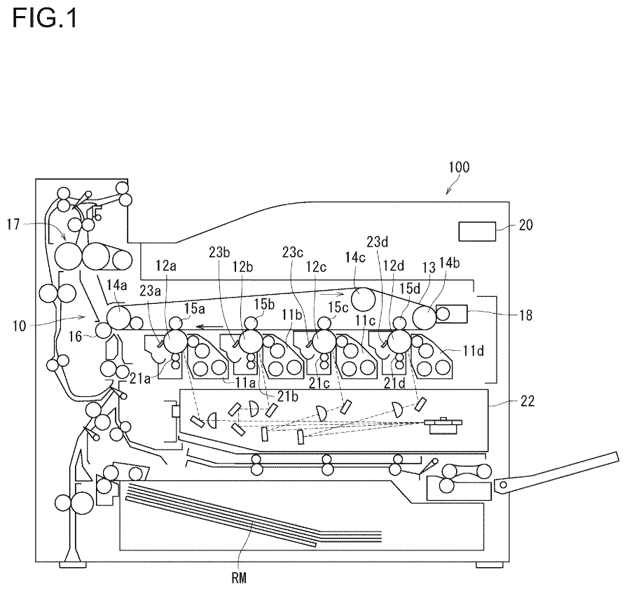

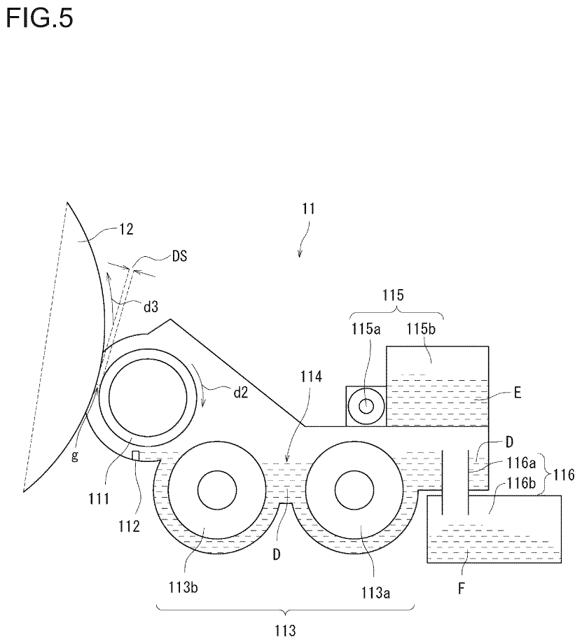

An image forming apparatus 100 which is an example of the image forming apparatus of the present embodiment will be described below with reference to FIG. 1. The image forming apparatus 100 shown in FIG. 1 includes a two-component developer (a developer being used D and a replenishment developer E, see FIG. 5), photosensitive members 12a to 12d, charging devices 21a to 21d, an exposure device 22, development devices 11a to 11d. a transfer device 10, cleaning blades 23a to 23d, a fixing device 17, an intermediate transfer belt cleaning device 18 and a control unit 20. In the following description, when there is no need to distinguish, each of the photosensitive members 12a to 12d is referred to as the photosensitive member 12, each of the charging devices 21a to 21d is referred to as the charging device 21, each of the development devices 11a to 11d is referred to as the development device 11 and each of the cleaning blades 23a to 23d is referred to as the cleaning blade 23.

The two-component developer includes the developer being used D and the replenishment developer E. The developer being used D includes at least an initial developer. The initial developer includes an initial carrier and the toner. The replenishment developer E includes a replenishment carrier and the toner. Each of the initial developer and the replenishment developer E is a two-component developer.

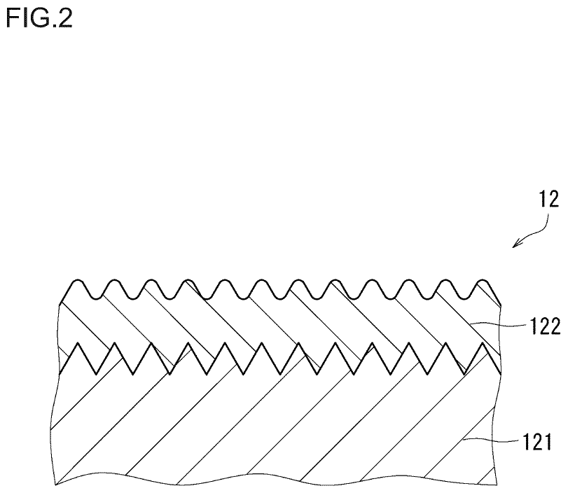

The photosensitive member 12 is cylindrical. As shown in FIG. 2, the photosensitive member 12 includes a cylindrical base member 121 (for example, a conductive base member) as a support member. The photosensitive member 12 includes an amorphous silicon photosensitive layer 122 on the outside of the base member 121. In other words, the photosensitive member 12 is an amorphous silicon photosensitive member. The photosensitive member 12 is rotatably supported. The photosensitive member 12 is driven by a motor (not shown) to rotate.

The base member 121 includes a roughened surface. The roughened surface has been subjected to blasting treatment. The base member 121 includes the roughened surface, and thus the surface of the amorphous silicon photosensitive layer 122 includes projections and recesses. In other words, the surface of the photosensitive member 12 includes projections and recesses.

The roughened surface may be further subjected to polishing treatment after the blasting treatment. The base member 121 after the blasting treatment may have sharp edges on its surface. When the amorphous silicon photosensitive layer 122 is formed on the base member 121 as described above, large variations in the thickness of the amorphous silicon photosensitive layer 122 are easily caused. Consequently, there is a tendency that it is difficult to control the arithmetic average roughness Ra of the surface of the photosensitive member 12 within a desired range. By contrast, in the roughened surface, the polishing treatment is performed after the blasting treatment, and thus edge portions which extremely protrude can be polished (peak cutting). As an abrasive material used in the polishing treatment, a soft material (such as a nonwoven fabric, a linen cloth or a paper towel) is preferable. A polishing rate during the polishing is preferably equal to or greater than 7% but equal to or less than 20%, and more preferably equal to or greater than 9% but equal to or less than 13%. The polishing rate is a difference between the arithmetic average roughness Ra (X) of the surface of the photosensitive member 12 before the blasting treatment and the arithmetic average roughness Ra (Y) of the surface of the photosensitive member 12 after the blasting treatment with respect to 100% of the arithmetic average roughness Ra (X) of the surface of the photosensitive member 12 before the blasting treatment (100×(X−Y)/X).

The arithmetic average roughness Ra of the surface (circumferential surface) of the photosensitive member 12 is equal to or greater than 37 nm but equal to or less than 105 nm, preferably equal to or greater than 50 nm but equal to or less than 105 nm and more preferably equal to or greater than 50 nm but equal to or less than 80 nm. The arithmetic average roughness Ra of the surface of the photosensitive member 12 is set equal to or greater than 37 nm, and thus a contact area between the photosensitive member 12 and the cleaning blade 23 can be reduced, with the result that a friction coefficient can be reduced. In this way, in the image forming apparatus of the present embodiment, the wear of the cleaning blade 23 during long-term use can be suppressed. The arithmetic average roughness Ra of the surface of the photosensitive member 12 is set equal to or less than 105 nm, and thus it is possible to suppress an excessive increase in the size of a gap between the cleaning blade 23 and the photosensitive member 12. In this way, in the image forming apparatus of the present embodiment, it is possible to suppress the passing of a contaminant (for example, contamination caused by the toner left after the transfer or the toner external additive) adhered to the surface of the photosensitive member 12 through the gap between the cleaning blade 23 and the photosensitive member 12. Consequently, in the image forming apparatus of the present embodiment, the surface of the photosensitive member 12 is appropriately cleaned over a long period of time, and thus it is possible to suppress the occurrence of contamination of the photosensitive member 12. In the image forming apparatus of the present embodiment, the occurrence of contamination of the photosensitive member 12 is suppressed, and thus it is also possible to suppress contamination of the charging device 21 in contact with the photosensitive member 12.

The arithmetic average roughness Ra of the surface of the photosensitive member 12 is measured, for example, by the method according to JIS (Japanese Industrial Standards) B0601 (Geometrical Product Specifications (GPS)—Surface Texture: Profile Method—Terms, Definitions And Surface Texture Parameters). The arithmetic average roughness Ra of the surface of the photosensitive member 12 can be adjusted by, for example, the surface roughness of the base member 121. The surface roughness of the base member 121 can be adjusted by a know method. For example, the arithmetic average roughness Ra of the surface of the photosensitive member 12 can be adjusted by changing treatment conditions (more specifically, a pressure at which a medium (abrasive grains) is jetted, a distance between a medium jet port and the surface of the base member, the shape and material of the medium and the like) when the base member 121 is subjected to the blasting treatment. However, in the image forming apparatus of the present embodiment, the base member 121 does not need to include the roughened surface. For example, the base member 121 may be mirror-finished. In this case, known roughening treatment is performed on the surface of the amorphous silicon photosensitive layer 122, and thus the desired arithmetic average roughness Ra can be provided to the surface of the photosensitive member 12.

The charging device 21 charges the circumferential surface of the photosensitive member 12. In FIG. 1, the charging device 21 is a charging roller. The exposure device 22 exposes the circumferential surface of the charged photosensitive member 12 to form an electrostatic latent image on the circumferential surface of the photosensitive member 12. For example, the electrostatic latent image is formed on the surface layer portion of the photosensitive member 12 (amorphous silicon photosensitive layer) based on image data.

The development device 11 uses the developer being used D to develop the electrostatic latent image into the toner image. More specifically, the development device 11 uses the developer being used D to develop the electrostatic latent image formed on the circumferential surface of the photosensitive member 12, and develops the electrostatic latent image into the toner image. Then, the photosensitive member 12 carries the toner image on the circumferential surface. The details of the development device 11 will be described later.

The transfer device 10 includes an intermediate transfer belt 13, a driving roller 14a, a driven roller 14b, a tension roller 14c, primary transfer rollers 15a to 15d and a secondary transfer roller 16. In the following description, when there is no need to distinguish, each of the primary transfer rollers 15a to 15d is referred to as the primary transfer roller 15. The intermediate transfer belt 13 is a seamless belt which is tensioned on the driving roller 14a, the driven roller 14b and the tension roller 14c. As the driving roller 14a is rotated, the intermediate transfer belt 13 is conveyed in a clockwise direction in FIG. 1 (direction d1 indicated by an arrow in FIG. 1). As the intermediate transfer belt 13 is conveyed, the driven roller 14b and the tension roller 14c are driven to rotate.

After the toner images are formed on the photosensitive members 12a to 12d, a bias (voltage) is applied to the primary transfer rollers 15a to 15d, and thus the toners (toner images) adhered to the photosensitive members 12a to 12d are primarily transferred to the intermediate transfer belt 13 in a sequential manner. In this way, the toner images of a plurality of colors are superimposed on the intermediate transfer belt 13. After the primary transfer, a bias (voltage) is applied to the secondary transfer roller 16, and thus the toner images of the colors on the intermediate transfer belt 13 are secondarily transferred to a recording medium RM (for example, a print sheet) being conveyed. Then, the toner images of the colors superimposed on the intermediate transfer belt 13 are secondarily transferred to the recording medium RM at a time. In this way, an image of the unfixed toners is formed on the recording medium RM.

### [Intermediate Transfer Belt]

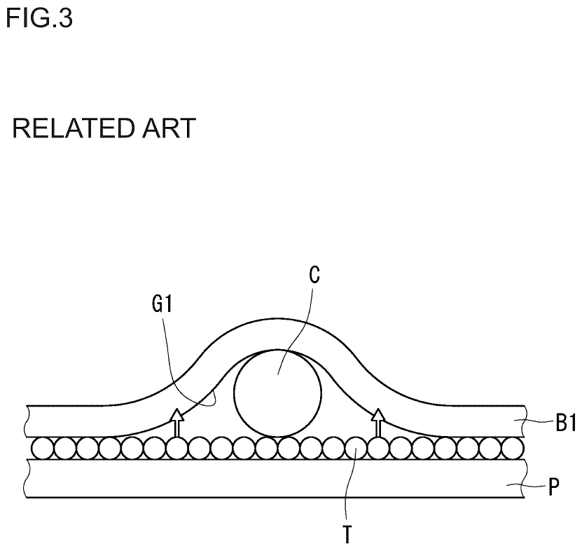

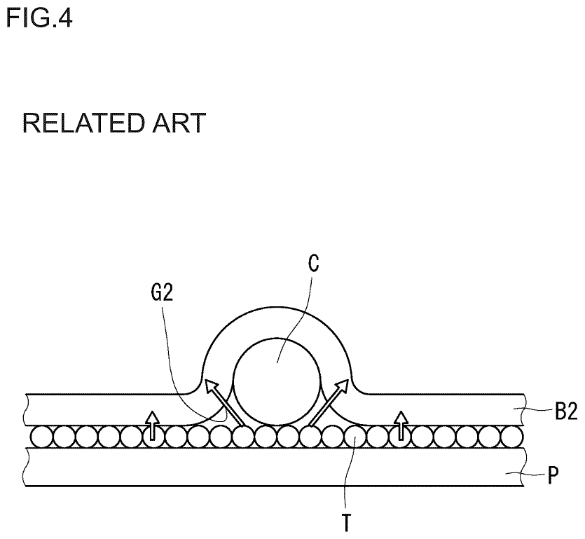

The intermediate transfer belt 13 contains a base resin and a conductive agent. The base resin includes a thermoplastic resin or a thermosetting resin. In other words, the intermediate transfer belt 13 is made of resin. Here, for example, a known image forming apparatus includes, as an intermediate transfer belt, an intermediate transfer belt made of rubber or an intermediate transfer belt made of resin. In the known image forming apparatus, the intermediate transfer belt made of rubber easily suppresses the generation of white spots as compared with the intermediate transfer belt made of resin. The reason for this will be described with reference to FIGS. 3 and 4.

FIG. 3 shows an example of a state where a toner image is transferred to an intermediate transfer belt B1 made of resin included in the known image forming apparatus. In FIG. 3, carrier development occurs, and thus a carrier C is developed on a photosensitive member P together with the toner T of the toner image. Arrows indicate a direction in which the toner T attempts to move. The carrier C inhibits the transfer of the toner T in contact with itself to the intermediate transfer belt B1 made of resin. The carrier C forms a gap G1 between the intermediate transfer belt B1 made of resin and the photosensitive member P. In the gap G1, the photosensitive member P and the intermediate transfer belt B1 are separate from each other. Hence, the toner T which is present in the gap G1 is unlikely to be transferred to the intermediate transfer belt B1. As described above, the carrier C which is developed by the carrier development on the photosensitive member P directly inhibits the transfer of the toner T in contact with itself, and simultaneously forms the gap G1 to indirectly inhibit the transfer of the toner T therearound (which may be described below as an indirect transfer inhibition caused by the carrier). In this way, white spots are generated.

FIG. 4 shows an example of a state where the toner image is transferred to an intermediate transfer belt B2 made of rubber included in the known image forming apparatus. In FIG. 4, as in FIG. 3, the carrier development occurs. However, the intermediate transfer belt B2 made of rubber is more flexible than the intermediate transfer belt B1 made of resin in FIG. 3. Hence, the intermediate transfer belt B2 made of rubber in contact with the carrier C deforms so as to envelop the carrier C. In this way, a gap G2 which is formed by the carrier C between the intermediate transfer belt B2 made of rubber and the photosensitive member P is smaller than the gap G1 in FIG. 3. Consequently, when the carrier development occurs, the gap G2 is relatively small, and thus in the known image forming apparatus including the intermediate transfer belt B2 made of rubber, the indirect transfer inhibition caused by the carrier is unlikely to occur. As a result, in the known image forming apparatus including the intermediate transfer belt B2 made of rubber, the generation of white spots caused by the carrier development is easily suppressed. The description has been given with reference to FIGS. 3 and 4.

As described above, in the known image forming apparatus, the intermediate transfer belt made of rubber is more advantageous than the intermediate transfer belt made of resin in terms of suppressing of the generation of white spots. However, in general, the intermediate transfer belt made of resin is cleaned with a rubber blade whereas the intermediate transfer belt made of rubber is cleaned with a brush. The brush has poorer cleaning performance than the rubber blade. Hence, as compared with the intermediate transfer belt made of resin, the intermediate transfer belt made of rubber has a disadvantage in that it is difficult to clean residual toners adhered to the surface thereof. Therefore, in the known image forming apparatus including the intermediate transfer belt made of rubber, an image failure easily occurs which is caused by a cleaning failure in the intermediate transfer belt made of rubber.

By contrast, the image forming apparatus 100 which is an example of the image forming apparatus of the present embodiment includes the toner which will be described later. The toner included in the image forming apparatus 100 has relatively low adhesion to the photosensitive member 12. Hence, in the image forming apparatus 100, even if a gap is generated by the carrier development between the photosensitive member 12 and the intermediate transfer belt 13 made of resin, the toner is easily transferred to the intermediate transfer belt 13 made of resin. In other words, in the image forming apparatus 100, the indirect transfer inhibition caused by the carrier is unlikely to occur. In this way, in the image forming apparatus 100, the generation of white spots can be suppressed while an advantage (it is possible to suppress the occurrence of an image failure caused by a cleaning failure in the intermediate transfer belt) provided by the use of the intermediate transfer belt 13 made of resin is being achieved.

In the intermediate transfer belt 13, the content of the base resin is preferably equal to or greater than 50% by mass but equal to or less than 95% by mass, and more preferably equal to or greater than 70% by mass but equal to or less than 87% by mass. In the intermediate transfer belt 13, the total content of the thermoplastic resin and the thermosetting resin in the base resin is preferably equal to or greater than 90% by mass, and more preferably equal to 100% by mass.

Examples of the base resin include polyphenylene sulfide (PPS), polyamide (PA), polyamideimide (PAI), polyetherimide (PEI), polyimide (PI), polyetheretherketone (PEEK), polyethersulfone (PES), polyphenylsulfone (PPSU), polysulfone (PSF), polyethylene terephthalate (PET), polybutylene terephthalate (PBT), polyacetal (POM), polycarbonate (PC), polyvinylidene fluoride (PVDF), polypropylene (PP), polyethylene (PE), polylactic acid (PLLA) and polyethylene naphthalate (PEN). The base resin may be a blend resin obtained by mixing the resins described above. The base resin is preferably polyamide (in particular, polyamide 12), polyimide, PVDF or PET.

Examples of the conductive agent include an electronic conductive agent and an ionic conductive agent. Examples of an electronic conductive material include carbon black, aluminum, copper, nickel, stainless steel, tin oxide, indium oxide, titanium oxide, zinc oxide, silver, polyaniline, polyacetylene and polyether ester amide. Examples of an ionic conductive material include an inorganic ionic conductive material and an organic ionic conductive material. Examples of the inorganic ionic conductive material include sodium perchlorate, lithium perchlorate, calcium perchlorate and lithium chloride. Examples of the organic ionic conductive material include modified aliphatic dimethyethylammonium ethosulfate, stearyl ammonium acetate, lauryl ammonium acetate, octadecyltrimethylammonium perchlorate, sulfate, ethosulfate, methylsulfate, phosphate, fluoroborate and acetate. The conductive agent is preferably carbon black, titanium oxide or polyether ester amide.

In the intermediate transfer belt 13, the content of the conductive agent is preferably equal to or greater than 10 parts by mass but equal to or less than 80 parts by mass with respect to 100 parts by mass of the base resin, and more preferably equal to or greater than 17 parts by mass but equal to or less than 30 parts by mass.

The intermediate transfer belt 13 can be manufactured, for example, by mixing the base resin (or its precursor) described above, a conductive material and another component (for example, a solvent) which is added as necessary, and then molding the mixture in the shape of a belt. Specific examples of a molding method include an extrusion molding method, an inflation method, a blow molding method, a dipping method and a centrifugal molding method.

After the secondary transfer, the fixing device 17 heats and pressurizes the toners on the recording medium RM to fix the toners to the recording medium RM. In this way, the image of the toners fixed to the recording medium RM is formed.

After the secondary transfer, the intermediate transfer belt cleaning device 18 cleans the toners left on the intermediate transfer belt 13.

The control unit 20 electronically controls the operation of the image forming apparatus 100 based on the outputs of various types of sensors. The control unit 20 includes, for example, a CPU (Central Processing Unit), a RAM (Random Access Memory) and a storage device which stores programs and stores predetermined data such that the predetermined data can be rewritten. A user provides an instruction (for example, an electrical signal) to the control unit 20 through an input unit (not shown). The input unit is, for example, a keyboard, a mouse or a touch panel.

### [Development Device]

The development device 11 included in the image forming apparatus 100 will then be further described with reference to FIG. 5. FIG. 5 shows the development device 11 and an area therearound in the image forming apparatus 100 shown in FIG. 1. The development device 11 includes at least a developer carrying member 111, a storage unit 114 and a replenishment unit 115. The development device 11 further includes a restriction blade 112, a plurality of stirring shafts 113 and a discharge unit 116.

The storage unit 114 stores the developer being used D (that is, a storage developer) and the stirring shafts 113. The developer being used D stored in the storage unit 114 includes at least the initial developer. The stirring shafts 113 include a first stirring shaft 113a and a second stirring shaft 113b. The first stirring shaft 113a includes a spiral stirring blade. The second stirring shaft 113b includes a spiral stirring blade which is directed in an opposite direction (which has an opposite phase) with respect to the spiral stirring blade included in the first stirring shaft 113. The first stirring shaft 113 conveys, while stirring the developer being used D in the storage unit 114, the developer being used D in a first conveyance direction (direction orthogonal to the plane of FIG. 5 and extending from the back to the front of the plane) which extends from one end side to the other end side in the axial direction of the developer carrying member 111. The second stirring shaft 113b conveys, while stirring the developer being used D in the storage unit 114, the developer being used D in a second conveyance direction opposite to the first conveyance direction. The developer being used D which includes the toner and the carrier is stirred, thus the toner is charged by the friction of the carrier and the charged toner is carried by the carrier. The second stirring shaft 113b supplies the developer being used D to the developer carrying member 111 while conveying the developer being used D in the second conveyance direction.

The replenishment unit 115 is provided on an upper portion of the storage unit 114. The replenishment unit 115 supplies the replenishment developer E to the storage unit 114. The replenishment unit 115 includes a supplied amount adjustment member 115a and a developer container 115b.

The supplied amount adjustment member 115a controls the amount of replenishment developer E supplied from the developer container 115b to the storage unit 114. The supplied amount adjustment member 115a is formed with, for example, a screw shaft the rotation operation of which is controlled by the control unit 20. For example, the supplied amount of replenishment developer E can be changed according to the amount of rotation of the screw shaft.

The developer container 115b stores the replenishment developer E. The replenishment developer E in the developer container 115b is supplied to the storage unit 114.

The discharge unit 116 discharges the developer being used D in the storage unit 114. The discharge unit 116 includes a discharge path 116a and a storage container 116b. The discharge path 116a couples the storage unit 114 and the storage container 116b. When the amount of developer being used D in the storage unit 114 exceeds a predetermined amount, an extra amount of developer being used D enters the discharge path 116a from an opening on the upper end side of the discharge path 116a. The predetermined amount is, for example, an amount which is determined by the position of the upper end of the discharge path 116a. The extra amount of developer being used D is, for example, an amount of developer being used D which exceeds the predetermined amount. When the extra amount of developer being used D enters the discharge path 116a, the extra amount of developer being used D moves downward in the discharge path 116a by gravity and flows into the storage container 116b. Then, the storage container 116b stores the extra amount of developer being used D. In the following description, the collected developer is referred to as the collected developer F.

In the unused image forming apparatus 100 (for example, after a shipment from a factory or before printing starts), the developer being used D stored in the storage unit 114 is the initial developer.

Before the replenishment unit 115 supplies the replenishment developer E into the storage unit 114 after the start of use of the image forming apparatus 100 (for example, after printing starts), the developer being used D stored in the storage unit 114 is the initial developer. In the storage unit 114, the initial developer is stirred with the stirring shafts 113, and thus the toner included in the initial developer is frictionally charged. Then, the stirred initial developer is carried by the developer carrying member 111.

When the image forming apparatus 100 continues to perform printing, the replenishment developer E is supplied into the storage unit 114, and the developer being used D is discharged from the storage unit 114. Hence, as the image forming apparatus 100 continues to perform printing, the developer being used D stored in the storage unit 114 is gradually replaced by the replenishment developer E supplied from the replenishment unit 115. Therefore, after the replenishment unit 115 supplies the replenishment developer E into the storage unit 114, the developer being used D stored in the storage unit 114 is the initial developer and the replenishment developer E. After the replenishment unit 115 supplies the replenishment developer E into the storage unit 114, in the storage unit 114, the initial developer and the replenishment developer E are stirred with the stirring shafts 113, and thus the toner included in the initial developer and the toner included in the replenishment developer E are frictionally charged. Then, the initial developer and the replenishment developer E which have been stirred are carried by the developer carrying member 111.

The development device 11 is a so-called development device 11 of a trickle development system which includes the storage unit 114, the replenishment unit 115 and the discharge unit 116. In the development device 11 of the trickle development system, after the development of an electrostatic latent image using the initial developer in the storage unit 114 is started, while the developer being used D in the storage unit 114 is being discharged and the replenishment developer E is being supplied into the storage unit 114, the electrostatic latent image is developed with the developer being used D in the storage unit 114. During the image formation, the carrier is also supplied into the storage unit 114 together with the toner, only an extra amount of carrier in the storage unit 114 caused by the supply of the carrier is discharged, and thus it is possible to suppress the deterioration of the carrier in the storage unit 114. The deterioration of the carrier is suppressed, and thus it is possible to reduce the number of times the carrier is replaced in the development device 11.

The developer carrying member 111 is arranged opposite the photosensitive member 12 via a development gap g. The development gap g is a gap when the developer carrying member 111 is closest to the photosensitive member 12. The developer carrying member 111 includes a magnet roll and a development sleeve. The magnet roll has a magnetic pole at least in its surface layer portion. The magnetic poles are, for example, north and south poles based on a permanent magnet. The development sleeve is a non-magnetic cylinder (for example, an aluminum pipe). The magnet roll is located in the development sleeve (in the cylinder), and the development sleeve is located in the surface layer portion of the developer carrying member 111. The shaft of the magnet roll and the development sleeve are connected via a flange so that the development sleeve can be rotated around the non-rotating magnet roll.

As already described, in the storage unit 114, the charged toner is carried by the carrier. The developer carrying member 111 (specifically, the development sleeve) attracts the carrier in the storage unit 114 by magnetic force while being rotated in a clockwise direction in FIG. 5 (direction d2 indicated by an arrow in FIG. 5), and thereby carries a chain of carrier particles carrying toner particles (that is, a magnetic brush of the developer being used D) on its circumferential surface. In this way, the developer carrying member 111 carries the developer being used D in the storage unit 114 on the circumferential surface, and conveys the developer being used D in the direction d2 indicated by the arrow.

The restriction blade 112 restricts the magnetic brush of the developer being used D formed on the circumferential surface of the developer carrying member 111 such that the magnetic brush has a predetermined thickness.

After the thickness of the magnetic brush is restricted by the restriction blade 112, the developer carrying member 111 (specifically, the development sleeve) is further rotated in the clockwise direction (direction d2 indicated by the arrow in FIG. 5), and thus the developer being used D is conveyed to the development gap g. The photosensitive member 12 is rotated in a counterclockwise direction in FIG. 5 (direction d3 indicated by an arrow in FIG. 5). A bias (voltage) is applied to the developer carrying member 111, and thus a potential difference is generated between the surface potential of the developer carrying member 111 and the surface potential of the photosensitive member 12. By the potential difference, the toner included in the developer being used D carried by the developer carrying member 111 is moved to the circumferential surface of the photosensitive member 12. Specifically, the charged toner included in the developer being used D carried by the developer carrying member 111 is attracted by electrical force to the electrostatic latent image (for example, an exposed part in which its potential is lowed below the potential of a non-exposed part by exposure) to be moved to the electrostatic latent image on the photosensitive member 12. Consequently, the toner image is formed on the circumferential surface of the photosensitive member 12.

The developer included in the image forming apparatus 100 will be described in detail later. As already described, the developer includes the developer being used D and the replenishment developer E. The developer being used D includes at least the initial developer.

The carrier development is a failure in which the carrier particles in the magnetic brush (that is, the chain of carrier particles carrying toner particles) carried by the developer carrying member 111 are moved to the photosensitive member 12. Once the carrier particles have been moved to the photosensitive member 12, the carrier particles have strong adhesion, and thus the carrier particles are unlikely to return to the developer carrying member 111. Then, the carrier particles which have been moved to the photosensitive member 12 contribute to the generation of white spots.

The width DS of the development gap g is preferably equal to or greater than 0.100 mm but equal to or less than 1.000 mm, and more preferably equal to or greater than 0.200 mm but equal to or less than 0.500 mm.

The image forming apparatus 100 has been described above with reference to FIGS. 1 to 5. However, the image forming apparatus of the present embodiment is not limited to the image forming apparatus 100 shown in FIG. 1. For example, the image forming apparatus of the present embodiment may be an image forming apparatus for forming a monochrome image. The image forming apparatus of the present embodiment may adopt a rotary system. The charging device may be a charging device other than the charging roller (for example, a scorotron charger, a charging brush or a corotron charger). In the image forming apparatus of the present embodiment, the configurations other than the two-component developer, the photosensitive member, the charging device, the development device and the intermediate transfer belt can be omitted. The image forming apparatus of the present embodiment does not need to adopt the trickle development system.

### [Two-Component Developer]

The two-component developer included in the image forming apparatus of the present embodiment will be described in detail below. The two-component developer includes the toner and the carrier. The toner includes the toner particles. The carrier includes the carrier particles. The two-component developer is, for example, a two-component developer used in an image forming apparatus of a development system other than the trickle development system (hereinafter also referred to as a general developer), the initial developer used in the image forming apparatus of the trickle development system or the replenishment developer used in the image forming apparatus of the trickle development system.

The two-component developer is obtained, for example, by using a mixer (more specifically, for example, a bowl mill or a rocking mixer (registered trademark)) to mix the carrier and the toner while stirring them.

In the general developer, a toner ratio (100×toner mass/carrier mass) which indicates the ratio of a toner mass to a carrier mass is preferably equal to or greater than 1% but equal to or less than 20%, and more preferably equal to or greater than 5% but equal to or less than 15%. In the replenishment developer, a carrier ratio (100×carrier mass/toner mass) which indicates the ratio of a carrier mass to a toner mass is preferably equal to or greater than 2% but equal to or less than 30%, and more preferably equal to or greater than 5% but equal to or less than 20%.

### [Carrier Particles]

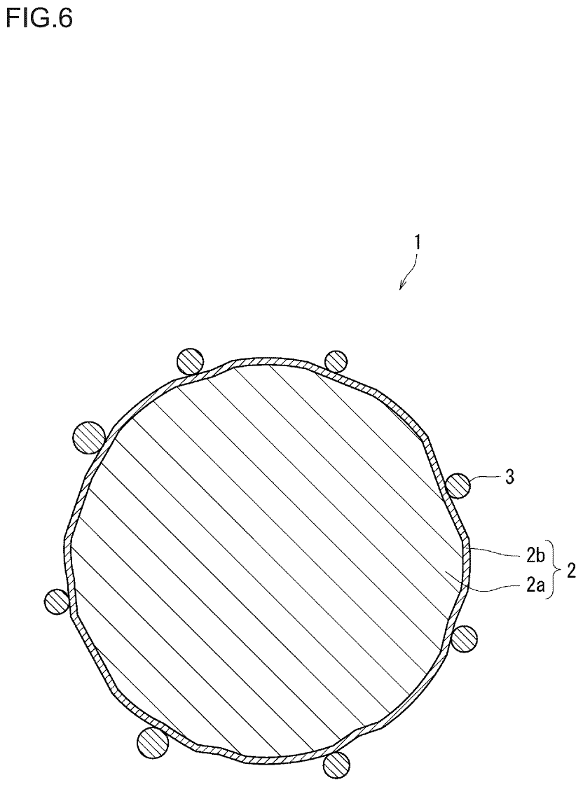

An example of the carrier particle included in the carrier will be described below with reference to a drawing. FIG. 6 shows a carrier particle 1 which is an example of the carrier particle. The carrier particle 1 include a carrier base particle 2 and a carrier external additive 3. The carrier base particle 2 includes a carrier core 2a and a coat layer 2b which coats the surface of the carrier core 2a. The coat layer 2b contains a coat resin. The coat layer 2b coats the entire surface of the carrier core 2a.

The carrier particle 1 has been described above with reference to FIG. 6. However, the carrier particle included in the carrier is not limited to the carrier particle 1 shown in FIG. 6. For example, the coat layer preferably coats at least a part of the carrier core. In other words, a part of the carrier core may be exposed. The coat layer may have a multilayer structure. Furthermore, the carrier particle does not need to include the carrier external additive. Furthermore, the carrier base particle does not need to include the coat layer.

### (Carrier Core)

The carrier core preferably contains a magnetic material. The carrier core may be particles of the magnetic material or may be particles which include a carrier core binding resin and particles of the magnetic material dispersed in the carrier core binding resin (hereinafter also referred to as a resin carrier core).

Examples of the magnetic material contained in the carrier core include ferromagnetic metals (more specifically, for example, iron, cobalt, nickel and an alloy including one or more of these metals) and a ferromagnetic metal oxide. Examples of the ferromagnetic metal oxide include ferrite and magnetite which is one type of spinel ferrite. Examples of the ferrite include Ba ferrite, Mn ferrite, Mn—Zn ferrite, Ni—Zn ferrite, Mn—Mg ferrite, Ca—Mg ferrite, Li ferrite, Cu—Zn ferrite and Mn—Mg—Sr ferrite. Examples of a method for manufacturing the carrier core include a method which includes a step of pulverizing and sintering the magnetic material. In the manufacturing of the carrier core, the saturation magnetization of the carrier can be adjusted by changing the amount of magnetic material added (in particular, the ratio of a ferromagnetic material). In the manufacturing of the carrier core, the circularity of the carrier core can be adjusted by changing a sintering temperature. A commercially available carrier core may be used.

Examples of the particles of the magnetic material used as the carrier core include ferrite particles. The ferrite particles tend to be sufficiently magnetic for forming an image with the two-component developer. There is a tendency that ferrite particles manufactured by a general method are not perfectly spherical and have moderate irregularities on the surface. When the carrier core is ferrite particles (ferrite core), in terms of enhancing adhesion between the surface of the ferrite core and the coat layer, the arithmetic average roughness of the surface of the ferrite core (specifically, the arithmetic average roughness Ra specified in JIS (Japanese Industrial Standards) B0601: 2013) is preferably equal to or greater than 0.3 μm but equal to or less than 2.0 μm.

As the binding resin in the resin carrier core, polyester resin, urethane resin or phenol resin is preferable, and phenol resin is more preferable. Examples of the particles of the magnetic material in the resin carrier core include particles which include one or more of the magnetic materials illustrated as the magnetic material.

In the carrier particles, the mass ratio of the carrier core to the total mass of the carrier core and the coat layer is preferably equal to or greater than 80% by mass but equal to or less than 99% by mass, and more preferably equal to or greater than 95% by mass but equal to or less than 99% by mass.

The number average primary particle diameter of the carrier core is preferably equal to or greater than 20 μm but equal to or less than 60 μm. The number average primary particle diameter of the carrier core is set equal to or greater than 20 μm, and thus it is possible to suppress the occurrence of the carrier development. The number average primary particle diameter of the carrier core is set equal to or less than 60 μm, and thus it is possible to optimize developability.

The saturation magnetization of the carrier core in an applied magnetic field of 3000 Oe is preferably equal to or greater than 60 emu/g but equal to or less than 80 emu/g. The saturation magnetization of the carrier core is set equal to or greater than 60 emu/g, and thus it is possible to suppress the occurrence of the carrier development. The saturation magnetization of the carrier core is set equal to or less than 80 emu/g, and thus it is possible to optimize developability.

### (Coat Layer)

The coat layer contains the coat resin. The coat layer preferably further contains at least one of metal oxide particles and carbon black. The thickness of the coat layer is, for example, equal to or greater than 0.3 μm but equal to or less than 2.0 μm.

The mass of the coat layer with respect to 100 parts by mass of the carrier core is preferably equal to or greater than 0.5 parts by mass but equal to or less than 10.0 parts by mass, and more preferably equal to or greater than 1.0 part by mass but equal to or less than 3.0 parts by mass. The mass of the coat layer is set equal to or greater than 0.5 parts by mass, and thus it is possible to suppress the exposure of the carrier core. The mass of the coat layer is set equal to or less than 5.0 parts by mass, and thus the carrier easily charges the toner.

Examples of the coat resin include fluorine resin and silicone resin. As the coat resin, the silicone resin is preferable. The content of the coat resin in the coat layer is preferably equal to or greater than 50.0% by mass but equal to or less than 90.0% by mass, and more preferably equal to or greater than 70.0% by mass but equal to or less than 85.0% by mass. The content of the silicone resin in the coat resin is preferably equal to or greater than 90% by mass, and more preferably equal to 100% by mass.

### (Silicone Resin)

The silicone resin is a resin which has a polysiloxane structure (for example, an alkylpolysiloxane structure). Examples of the silicone resin include a silicone resin including a methyl group and an epoxy resin-modified silicone resin. Examples of the silicone resin including a methyl group include a silicone resin which includes a methyl group and does not include a phenyl group (hereinafter also referred to as a “methyl silicone resin”) and a silicone resin which includes a methyl group and a phenyl group (hereinafter also referred to as a “methyl phenyl silicone resin”). As the silicone resin, the methyl silicone resin is preferable.

### (Metal Oxide Particles)

As the metal oxide particles, ferroelectric metal oxide particles (for example, strontium titanate particles or barium titanate particles) are preferable, and barium titanate particles are more preferable. The coat layer contains the metal oxide particles, and thus the two-component developer easily provides a desired amount of charging to the toner. The coat layer contains the metal oxide particles (in particular, barium titanate particles), and thus it is possible to optimize the strength of the coat layer, with the result that it is possible to suppress the embedding of the carrier external additive in the coat layer.

The number average primary particle diameter of the metal oxide particles is preferably equal to or greater than 100 nm but equal to or less than 500 nm, and more preferably equal to or greater than 250 nm but equal to or less than 350 nm. The number average primary particle diameter of the metal oxide particles is set equal to or greater than 100 nm, and thus the two-component developer more easily provides the desired amount of charging to the toner. The number average primary particle diameter of the metal oxide particles is set equal to or less than 500 nm, and thus it is possible to suppress the detaching of the metal oxide particles from the coat layer.

In the coat layer, the content of the metal oxide particles with respect to 100 parts by mass of the coat resin is preferably equal to or greater than 5 parts by mass but equal to or less than 50 parts by mass, and more preferably equal to or greater than 10 parts by mass but equal to or less than 30 parts by mass. The content of the metal oxide particles is set equal to or greater than 5 parts by mass, and thus the two-component developer more easily provides the desired amount of charging to the toner. The content of the metal oxide particles is set equal to or less than 50 parts by mass, and thus it is possible to suppress the detaching of the metal oxide particles from the coat layer.

### (Carbon Black)

The carbon black promotes the movement of charge in the coat layer. Consequently, the two-component developer easily provides the desired amount of charging to the toner.

The number average primary particle diameter of the carbon black is preferably equal to or greater than 10 nm but equal to or less than 200 nm, and more preferably equal to or greater than 20 nm but equal to or less than 60 nm. The number average primary particle diameter of the carbon black particles is set equal to or greater than 10 nm, and thus the two-component developer more easily provides the desired amount of charging to the toner. The number average primary particle diameter of the carbon black is set equal to or less than 200 nm, and thus it is possible to suppress the detaching of the carbon black from the coat layer.

In the coat layer, the content of the carbon black with respect to 100 parts by mass of the coat resin is preferably equal to or greater than 1 part by mass but equal to or less than 20 parts by mass, and more preferably equal to or greater than 6 parts by mass but equal to or less than 12 parts by mass. The content of the carbon black is set equal to or greater than 1 part by mass, and thus the two-component developer more easily provides the desired amount of charging to the toner. The content of the carbon black is set equal to or less than 20 parts by mass, and thus it is possible to suppress the detaching of the carbon black from the coat layer.

### (Other Components)

The coat layer may further contain components other than the coat resin, the metal oxide particles and the carbon black. Examples of the other components include a charge control agent, an adhesion promoter and a crosslinking agent.

### (Carrier External Additive)

The carrier external additive optimizes the fluidity of the carrier and promotes the transfer of charge from the carrier particles to the toner particles. Examples of the carrier external additive include metal oxide particles. Examples of the metal oxide particles include the same particles which are described as the metal oxide particles included in the coat layer. The carrier external additive preferably contains strontium titanate particles. The content of the strontium titanate in the carrier external additive is preferably equal to or greater than 90% by mass, and more preferably equal to 100% by mass.

The strontium titanate particles may be doped. When the strontium titanate particles are doped, the amount of element with which the strontium titanate particles are doped may be equal to or less than 1.00% by mass with respect to all the mass of the strontium titanate particles, may be equal to or less than 0.10% by mass or may be less than 0.01% by mass. However, the strontium titanate particles do not need to be doped. The strontium titanate particles may be formed of undoped strontium titanate. For example, the strontium titanate particles may be formed of strontium titanate which is not doped with lanthanum and group 5 elements of the periodic table (for example, niobium and tantalum).

The number average primary particle diameter of the carrier external additive is preferably equal to or greater than 15 nm but equal to or less than 85 nm, more preferably equal to or greater than 20 nm but equal to or less than 70 nm and further preferably equal to or greater than 25 nm but equal to or less than 40 nm.

The number average primary particle diameter of the carrier external additive is preferably smaller than the arithmetic average roughness Ra of the surface of the photosensitive member for the following reasons. As described previously, projections and recesses are present in the surface of the photosensitive member. Hence, the toner components (for example, the binding resin and a mold release agent) may be adhered to the recesses in the surface of the photosensitive member. A state where the toner components are adhered to the recesses in the surface of the photosensitive member is maintained, and thus the charging performance and the like of the photosensitive member may be lowered. By contrast, in the configuration described above, when the magnetic brush makes contact with the photosensitive member in the development, the carrier external additive included in the magnetic brush penetrates the recesses in the surface of the photosensitive member, and thus it is possible to scrape the toner components from the recesses. Consequently, the image forming apparatus of the present embodiment can further effectively suppress the contamination of the photosensitive member.

In terms of forming an image which has a desired image density with a small amount of fog, the amount of carrier external additive is preferably equal to or greater than 0.01 parts by mass but equal to or less than 0.20 parts by mass with respect to 100.00 parts by mass of the carrier base particle, and more preferably equal to or greater than 0.02 parts by mass but equal to or less than 0.06 parts by mass.

The coverage ratio of the carrier external additive in the carrier particle is preferably equal to or greater than 5.0% by area but equal to or less than 35.0% by area, and more preferably equal to or greater than 10.0% by area but equal to or less than 20.0% by area. The coverage ratio of the carrier external additive is set equal to or greater than 5.0% by area, and thus the carrier external additive easily achieves its function. The coverage ratio of the carrier external additive is set equal to or less than 35.0% by area, and thus it is possible to suppress the detaching of the carrier external additive from the carrier base particle.

### (Method for Manufacturing Carrier)

A method for manufacturing the carrier includes, for example, a step of forming the carrier base particle and a step of external addition to the carrier base particle.

### (Step of Forming Carrier Base Particle)

In the present step, a coat solution is applied to the surface of the carrier core. The coat solution contains the coat resin and a solvent. The solid content concentration of the coat solution is preferably equal to or greater than 10% by mass but equal to or less than 30% by mass.

Examples of the solvent for the coat solution include lactam compounds (for example, 2-pyrrolidone and N-methyl-2-pyrrolidone), ketone compounds (for example, methyl ethyl ketone and methyl isobutyl ketone), cyclic ether compounds (for example, tetrahydrofuran and tetrahydropyran), alcohol compounds (for example, normal butanol and isobutanol), ester solvents (for example, ethyl acetate and isobutyl acetate) and aromatic hydrocarbon compounds (for example, toluene and xylene). As the solvent for the coat solution, toluene is preferable.

Examples of a method for applying the coat solution to the surface of the carrier core include a method for immersing the carrier core in the coat solution and a method for spraying the coat solution to the carrier core in a fluidized bed. In the method for immersing the carrier core in the coat solution, a small amount of coat solution is applied to the projections in the surface of the carrier core whereas a large amount of coat solution is applied to the recesses in the surface of the carrier core, with the result that the amount of coat solution applied tends to be uneven. By contrast, in the method for spraying the coat solution to the carrier core in the fluidized bed, there is a tendency that the coat solution can be evenly applied both to the projections and the recesses in the surface of the carrier core. Hence, as the method for applying the coat solution to the surface of the carrier core, the method for spraying the coat solution to the carrier core in the fluidized bed is preferable.

In the present step, the carrier core after the application step is heated, and thus the solvent included in the coat solution is removed. When the coat solution includes the uncured coat resin, the uncured coat resin is thermally cured. Consequently, the coat layer is formed from the coat solution. A heating temperature during the heating is preferably equal to or greater than 100° C. but equal to or less than 300° C., and more preferably equal to or greater than 180° C. but equal to or less than 220° C. A heating time during the heating is preferably equal to or greater than 30 minutes but equal to or less than 90 minutes, and more preferably equal to or greater than 50 minutes but equal to or less than 70 minutes.

### (Step of External Addition to Carrier Base Particle)

In the present step, for example, a mixer is used to mix the carrier base particle and the carrier external additive. By the mixing, the carrier external additive is adhered to the surface of the carrier base particle, and the carrier including the carrier particles is obtained. The mixing in the step of external addition to the carrier base particle is preferably performed under a condition in which the carrier external additive is not fully embedded in the carrier base particle.

### [Toner]

The toner includes the toner particles. The toner particle includes a toner base particle and a toner external additive which is adhered to the surface of the toner base particle. The toner external additive includes spacer particles. The toner will be described in detail below with reference to a drawing as necessary.

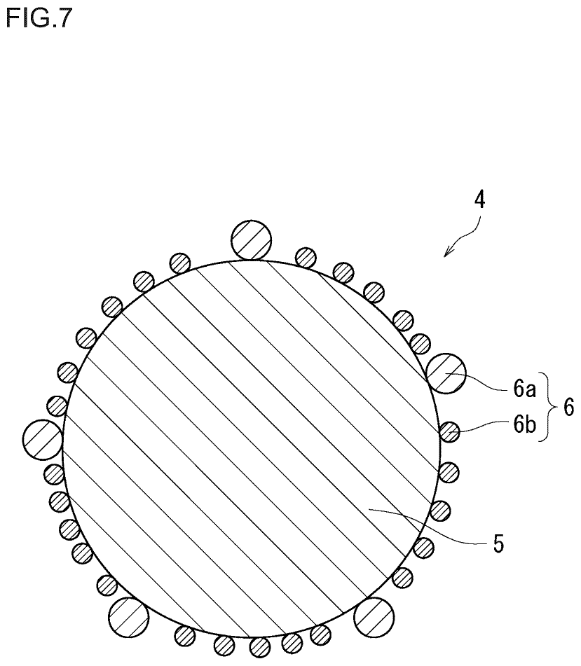

FIG. 7 shows an example of the toner particle 4 included in the toner. The toner particle 4 shown in FIG. 7 includes the toner base particle 5 and the toner external additive 6 adhered to the surface of the toner base particle 5. The toner external additive 6 includes the spacer particles 6a and silica particles 6b.

The toner particle has been described above with reference to the drawing. However, the toner particle may have a structure different from the toner particle 4 shown in FIG. 7. Specifically, the toner external additive may include only the spacer particles. The toner external additive may include toner external additive particles other than the spacer particles and the silica particles. The toner base particle may be a capsule toner particle which includes a toner core and a shell layer coating the toner core.

### (Toner External Additive)

The toner external additive is adhered to the surface of the toner base particle. The toner external additive includes the spacer particles. Preferably, the toner external additive further includes base silica particles which do not apply to the spacer particles. The toner external additive may further include particles (hereinafter, other toner external additive particles) other than the spacer particles and the base silica particles. The total content of the spacer particles and the base silica particles in the toner external additive is preferably equal to or greater than 60% by mass but equal to or less than 90% by mass.

### (Spacer Particle)

The number average primary particle diameter of the spacer particles is greater than the arithmetic average roughness Ra of the surface of the photosensitive member. The number average primary particle diameter of the spacer particles is preferably equal to or greater than 38 nm but equal to or less than 140 nm, more preferably equal to or greater than 45 nm but equal to or less than 140 nm, further preferably equal to or greater than 65 nm but equal to or less than 120 nm and particularly preferably equal to or greater than 90 nm but equal to or less than 110 nm. The number average primary particle diameter of the spacer particles is set equal to or greater than 38 nm, and thus it is possible to effectively achieve the function of the spacer particle. The number average primary particle diameter of the spacer particles is set equal to or less than 140 nm, and thus it is possible to effectively suppress the detaching of the spacer particle from the toner base particle.

Examples of the spacer particle include a silica particle (hereinafter, the silica particle used as the spacer particle may be referred to as a “spacer silica particle”), a resin particle, an aluminum oxide particle, a magnesium oxide particle, a zinc oxide particle and a composite particle obtained by combining these particles. As the spacer particle, the spacer silica particle or the resin particle is preferable, and the resin particle is more preferable. The resin particle is used as the spacer particle, and thus it is possible to optimize the melting properties of the toner.

As a resin contained in the spacer particle, a styrene-(meth)acrylic resin is preferable. The content of the styrene-(meth)acrylic resin in the spacer particle is preferably equal to or greater than 70% by mass, more preferably equal to or greater than 95% by mass and further preferably equal to 100% by mass.

The styrene-(meth)acrylic resin is a copolymer of a styrene compound and a (meth)acrylic acid compound. Examples of the (meth)acrylic acid compound include (meth)acrylic acid, (meth)acrylonitrile and (meth)acrylic acid alkyl ester (in particular, (meth)acrylic acid alkyl ester including an alkyl group having 1 to 4 carbon atoms in an ester moiety). As the (meth)acrylic acid compound, the (meth)acrylic acid alkyl ester is preferable.

Examples of the styrene compound include styrene, alkylstyrenes (more specifically, α-methylstyrene, o-methylstyrene, m-methylstyrene, p-methylstyrene, ethylstyrene, 2,3-dimethylstyrene, 2,4-dimethylstyrene, o-tert-butylstyrene, m-tert-butylstyrene, p-tert-butylstyrene and the like) and halogenated styrenes (more specifically, α-chlorostyrene, o-chlorostyrene, m-chlorostyrene, p-chlorostyrene and the like). As the styrene compound, styrene is preferable.

The content of a first repeating unit derived from the styrene compound with respect to all the repeating units included in the styrene-(meth)acrylic resin is preferably equal to or greater than 5.0% by mass but equal to or less than 40.0% by mass, and more preferably equal to or greater than 15.0% by mass but equal to or less than 25.0% by mass.

Examples of the (meth)acrylic acid alkyl ester include methyl (meth)acrylate, ethyl (meth)acrylate, n-propyl (meth)acrylate, isopropyl (meth)acrylate, butyl (meth)acrylate (specifically, n-butyl (meth)acrylate), isobutyl (meth)acrylate and 2-ethylhexyl (meth)acrylate. As the (meth)acrylic acid alkyl ester, the butyl (meth)acrylate is preferable.

The content of a second repeating unit derived from the (meth)acrylic acid compound with respect to all the repeating units included in the styrene-(meth)acrylic resin is preferably equal to or greater than 20.0% by mass but equal to or less than 60.0% by mass, and more preferably equal to or greater than 35.0% by mass but equal to or less than 45.0% by mass.

Preferably, the styrene-(meth)acrylic resin further includes a third repeating unit derived from the crosslinking agent. Specifically, the styrene-(meth)acrylic resin is preferably a crosslinked styrene-(meth)acrylic resin which includes the first repeating unit derived from the styrene compound, the second repeating unit derived from the (meth)acrylic acid compound and the third repeating unit derived from the crosslinking agent. The spacer particle contains the crosslinked styrene-(meth)acrylic resin as described above, and thus appropriate rigidity is provided to the spacer particle, with the result that the function of the spacer particle is easily achieved.

Examples of the crosslinking agent include a compound which includes two or more vinyl groups. Specific examples of the crosslinking agent include N,N′-methylenebisacrylamide, divinylbenzene, ethylene glycol diacrylate, ethylene glycol dimethacrylate, diethylene glycol diacrylate, tetraethylene glycol diacrylate, polyethylene glycol diacrylate, 1,4-butanediol diacrylate, 1,6-hexanediol diacrylate, tripropylene glycol diacrylate, trimethylolpropane triacrylate, pentaerythritol triacrylate, pentaerythritol tetraacrylate, 1,4-butanediol dimethacrylate and 1,6-hexanediol dimethacrylate. As the crosslinking agent, divinylbenzene is preferable.

The content of the third repeating unit with respect to all the repeating units included in the styrene-(meth)acrylic resin is preferably equal to or greater than 20.0% by mass but equal to or less than 60.0% by mass, and more preferably equal to or greater than 35.0% by mass but equal to or less than 45.0% by mass. The content of the third repeating unit is set equal to or greater than 20.0% by mass, and thus appropriate rigidity is provided to the spacer particle, with the result that the function of the spacer particle serving as a spacer is more easily achieved. The content of the third repeating unit is set equal to or less than 60.0% by mass, and thus it is possible to effectively suppress an excessive increase in the hardness of the spacer particle which causes the surface of the photosensitive member to be polished.

A crosslinking resin preferably includes a repeating unit derived from styrene, a repeating unit derived from butyl methacrylate and a repeating unit derived from divinylbenzene.

In terms of sufficiently achieving the function of the spacer particle while suppressing the detaching of the spacer particle from the toner base particle, the content of the spacer particle in the toner particle is preferably equal to or greater than 0.10 parts by mass but equal to or less than 5.00 parts by mass with respect to 100.00 parts by mass of the toner base particle, more preferably equal to or greater than 0.40 parts by mass but equal to or less than 2.20 parts by mass and further preferably equal to or greater than 0.80 parts by mass but equal to or less than 1.50 parts by mass. The content of the spacer particle is set equal to or greater than 0.10 parts by mass, and thus the function of the spacer particle is easily achieved sufficiently. The content of the spacer particle is set equal to or less than 5.00 parts by mass, and thus it is possible to suppress the detaching of the spacer particle from the toner base particle.

The coverage ratio of the spacer particle in the toner particle is preferably equal to or greater than 7% by area but equal to or less than 45% by area, and more preferably equal to or greater than 15% by area but equal to or less than 35% by area. The coverage ratio of the spacer particle is set equal to or greater than 7% by area, and thus the spacer particle easily achieves its function. The coverage ratio of the spacer particle is set equal to or less than 45% by area, and thus it is possible to suppress the detaching of the spacer particle from the toner base particle.

When the spacer particle is the resin particle, as a method for manufacturing the resin particle, for example, a known method (for example, a suspension polymerization method or a phase inversion emulsification method) can be adopted. Examples of a polymerization initiator used in the manufacturing of the resin particle include inorganic peroxides (for example, potassium persulfate, ammonium persulfate and hydrogen peroxide), organic peroxides (for example, t-butyl peroxide, cumene hydroxyperoxide and paramenthane peroxide) and azo compounds (for example, azobisdiisobutylnitrile and 2,2′-azobis(2-amidinopropane)dihydrochloride), and the inorganic peroxide or the organic peroxide is preferable.

When the spacer particle is the spacer silica particle, as a method for manufacturing the spacer silica particle, for example, a dry method can be adopted. On the spacer silica particle, at least one of positive charging treatment and hydrophobic treatment may be performed by a surface treatment agent.

### (Base Silica Particle)

The number average primary particle diameter of the base silica particles is smaller than the arithmetic average roughness Ra of the surface of the photosensitive member. As the base silica particles, silica particles which have been subjected to hydrophobic surface treatment are preferable. The number average primary particle diameter of the base silica particles is preferably equal to or greater than 20 nm but equal to or less than 60 nm, and more preferably equal to or greater than 20 nm but equal to or less than 35 nm. The number average primary particle diameter of the base silica particles is set equal to or greater than 20 nm, and thus it is possible to suppress the embedding of the base silica particle in the toner base particle. The number average primary particle diameter of the base silica particles is set equal to or less than 60 nm, and thus it is possible to suppress the detaching of the base silica particle from the toner base particle.

In terms of sufficiently achieving the function of the base silica particle while suppressing the detaching of the base silica particle from the toner base particle, the content of the base silica particle in the toner particle is preferably equal to or greater than 0.10 parts by mass but equal to or less than 10.00 parts by mass with respect to 100.00 parts by mass of the toner base particle, and more preferably equal to or greater than 0.50 parts by mass but equal to or less than 2.50 parts by mass.

### (Other Toner External Additive Particles)

The number average primary particle diameter of the other toner external additive particles is smaller than the arithmetic average roughness Ra of the surface of the photosensitive member. As the other toner external additive particles, metal oxide particles (more specifically, aluminum oxide particles, titanium oxide particles, magnesium oxide particles, zinc oxide particles, strontium titanate particles or barium titanate particles) are preferable, and the aluminum oxide particles are more preferable. The number average primary particle diameter of the metal oxide particles is preferably equal to or greater than 5 nm but equal to or less than 50 nm, and more preferably equal to or greater than 10 nm but equal to or less than 20 nm. The number average primary particle diameter of the strontium titanate particles is preferably equal to or greater than 10 nm but equal to or less than 50 nm, and more preferably equal to or greater than 20 nm but equal to or less than 40 nm.

In terms of sufficiently achieving the function of the other toner external additive particles while suppressing the detaching of the other toner external additive particles from the toner base particle, the content of the other toner external additive particles is preferably equal to or greater than 0.10 parts by mass but equal to or less than 5.00 parts by mass with respect to 100.00 parts by mass of the toner base particle, and more preferably equal to or greater than 1.00 part by mass but equal to or less than 2.00 parts by mass.

### (Toner Base Particle)

The toner base particle contains, for example, at least one selected from the group consisting of a binding resin, a colorant, a charge control agent and a mold release agent. The binding resin, the colorant, the charge control agent and the mold release agent will be described below.

### (Binding Resin)

In order to obtain a toner having excellent low-temperature fixing properties, the toner base particle preferably contains a thermoplastic resin as the binding resin, and more preferably contains a thermoplastic resin in a proportion of 85% or more by mass of the entire binding resin. Examples of the thermoplastic resin include polyester resins, styrene resins, acrylic ester resins (more specifically, an acrylic ester polymer, a methacrylic ester polymer and the like), olefin resins (more specifically, a polyethylene resin, a polypropylene resin and the like), vinyl resins (more specifically, a vinyl chloride resin, polyvinyl alcohol, a vinyl ether resin, an N-vinyl resin and the like), polyamide resins and urethane resins. Copolymers of these resins, that is, copolymers in which any repeating unit has been introduced into the above resins (more specifically, styrene-acrylic resins, styrene-butadiene resins and the like) can be used as the binding resin.

As the binding resin, the polyester resin is preferable. The polyester resin is a polymer of one or more polyhydric alcohol monomers and one or more polycarboxylic acid monomers. Instead of the polycarboxylic acid monomer, a polycarboxylic acid derivative (more specifically, a polycarboxylic acid anhydride, a polycarboxylic acid halide or the like) may be used.

Examples of the polyhydric alcohol monomer include a diol monomer, a bisphenol monomer and a trihydric or higher alcohol monomer.

Examples of the diol monomer include ethylene glycol, diethylene glycol, triethylene glycol, 1,2-propanediol, 1,3-propanediol, 1,4-butanediol, neopentyl glycol, 2-butene-1,4-diol, 1,5-pentanediol, 1,6-hexanediol, 1,4-cyclohexanedimethanol, 1,4-benzenediol, dipropylene glycol, polyethylene glycol, polypropylene glycol and polytetramethylene glycol.

Examples of the bisphenol monomer include bisphenol A, hydrogenated bisphenol A, a bisphenol A ethylene oxide adduct and a bisphenol A propylene oxide adduct.

Examples of the trihydric or higher alcohol monomer include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane and 1,3,5-trihydroxymethylbenzene.

Examples of the polycarboxylic acid monomer include a divalent carboxylic acid monomer and a trivalent or higher carboxylic acid monomer.

Examples of the divalent carboxylic acid monomer include maleic acid, fumaric acid, citraconic acid, itaconic acid, glutaconic acid, phthalic acid, isophthalic acid, terephthalic acid, 5-sulfoisophthalic acid, sodium 5-sulfoisophthalate, cyclohexanedicarboxylic acid, adipic acid, sebacic acid, azelaic acid, malonic acid, succinic acid, alkylsuccinic acid and alkenylsuccinic acid. Examples of the alkylsuccinic acid include n-butyl succinic acid, isobutyl succinic acid, n-octyl succinic acid, n-dodecyl succinic acid and isododecyl succinic acid. Examples of the alkenylsuccinic acid include n-butenyl succinic acid, isobutenyl succinic acid, n-octenyl succinic acid, n-dodecenyl succinic acid and isododecenyl succinic acid.

Examples of the trivalent or higher carboxylic acid monomer include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid and empol trimer acid.

The polyester resin is preferably a polymer of a bisphenol monomer, a divalent carboxylic acid monomer and a trivalent carboxylic acid monomer, and is more preferably a polymer of a bisphenol A alkylene oxide adduct, terephthalic acid, isophthalic acid and trimellitic acid.

The polyester resin is preferably an amorphous polyester resin. For the amorphous polyester resin, it is often impossible to measure a clear melting point. Hence, a polyester resin which do not show a clear endothermic peak in an endothermic curve measured with a differential scanning calorimeter may be determined to be an amorphous polyester resin.

### (Colorant)

As the colorant, a known pigment or dye can be used according to the color of the toner. Examples of the colorant include a black colorant, a yellow colorant, a magenta colorant and a cyan colorant.

An example of the black colorant is carbon black. The black colorant may be a colorant which is toned to black using a yellow colorant, a magenta colorant and a cyan colorant.

In the toner, the content of the colorant is preferably equal to or greater than 1.0 part by mass but equal to or less than 20.0 parts by mass with respect to 100.0 parts by mass of the binding resin, and more preferably equal to or greater than 3.0 parts by mass but equal to or less than 7.0 parts by mass.

### (Charge Control Agent)

The charge control agent is used, for example, in order to obtain a toner which has excellent charging stability and an excellent charging rise property. The charging rise property of the toner serves as an index of whether the toner can be charged to a predetermined charging level for a short period of time. Examples of the charging control agent include a positive charge control agent and a negative charge control agent. The positive charge control agent is contained in the toner base particle, and thus the cationic property (positive chargeability) of the toner can be strengthened whereas the negative charge control agent is contained in the toner base particle, and thus the anionic property (negative chargeability) of the toner can be strengthened. Examples of the positive charge control agent include pyridine, nigrosine and a quaternary ammonium salt. Examples of the negative charge control agent include a metal-containing azo dye, a sulfo group-containing resin, an oil-soluble dye, a naphthenic acid metal salt, an acetylacetone metal complex, a salicylic acid metal complex, a boron compound, a fatty acid soap and a long-chain alkyl carboxylate. However, if sufficient chargeability is ensured in the toner, it is not necessary to contain the charge control agent in the toner base particle. In the toner base particle, the content of the charge control agent is preferably equal to or greater than 0.1 parts by mass but equal to or less than 5.0 parts by mass with respect to 100.00 parts by mass of the binding resin, and more preferably equal to or greater than 0.4 parts by mass but equal to or less than 2.5 parts by mass.

### (Mold Release Agent)

The mold release agent is used, for example, in order to obtain a toner which has excellent hot offset resistance. Examples of the mold release agent include aliphatic hydrocarbon waxes, oxides of aliphatic hydrocarbon waxes, plant-derived waxes, animal-derived waxes, mineral-derived waxes, ester waxes containing fatty acid esters as the main component and waxes in which fatty acid esters are partially or completely deoxidized. Examples of the aliphatic hydrocarbon wax include polyethylene waxes (for example, low molecular weight polyethylene), polypropylene waxes (for example, low molecular weight polypropylene), polyolefin copolymers, polyolefin waxes, microcrystalline waxes, paraffin waxes and Fischer-Tropsch waxes. Examples of the oxide of the aliphatic hydrocarbon wax include oxidized polyethylene waxes and block copolymers of oxidized polyethylene waxes. Examples of the plant-derived wax include a candelilla wax, a carnauba wax, a wood wax, a jojoba wax and a rice wax. Examples of the animal-derived wax include a bees wax, lanolin and spermaceti. Examples of the mineral-derived wax include ozokerite, ceresin and petrolatum. Examples of the ester wax containing the fatty acid ester as the main component include a montan acid ester wax and a castor wax. Examples of the wax in which the fatty acid ester is partially or completely deoxidized include a deacidified carnauba wax. In the toner base particle, the content of the mold release agent is preferably equal to or greater than 1.0 part by mass but equal to or less than 20.0 parts by mass with respect to 100.0 parts by mass of the binding resin, and more preferably equal to or greater than 3.0 parts by mass but equal to or less than 10.0 parts by mass.

The toner particle may further contain a known additive as necessary. The volume median diameter of the toner particle is preferably equal to or greater than 4.0 μm but equal to or less than 12.0 μm. The volume median diameter of the toner base particle is preferably equal to or greater than 4.0 μm but equal to or less than 12.0 μm, and more preferably equal to or greater than 5.0 μm but equal to or less than 9.0 μm. The toner particle is preferably a non-magnetic toner.

### (Method for Manufacturing Toner)

An example of a method for manufacturing the toner will be described. The method for manufacturing the toner includes a toner base particle preparation step of preparing the toner base particle and an external addition step of adhering the toner external additive to the surface of the toner base particle. The toner external additive includes the spacer particle.

### (Toner Base Particle Preparation Step)

In the toner base particle preparation step, for example, the toner base particle is prepared by a pulverizing method or an agglomeration method. In the toner base particle preparation step, the toner base particle is preferably prepared by the pulverizing method. In other words, in the toner, the toner base particle is preferably a pulverized toner base particle.

In an example of the pulverizing method, the binding resin and other components to be added as necessary are first mixed. Then, the resulting mixture is melt-kneaded using a melt-kneading device (for example, a single-screw or twin-screw extruder). Then, the resulting melt-kneaded product is pulverized and classified. In this way, the toner base particles are obtained.

In an example of the agglomeration method, minute particles of the binding resin and other components to be added as necessary are agglomerated in an aqueous medium containing the minute particles until the minute particles have a desired particle diameter. In this way, agglomerated particles containing the binding resin and the like are formed. Then, the resulting agglomerated particles are heated, and thus the components contained in the agglomerated particles are unified. In this way, the toner base particles are obtained.

### (External Addition Step)

In the present step, the toner external additive is adhered to the surface of the toner base particle. As a method of adhering the toner external additive to the surface of the toner base particle, for example, a method of using a mixing device to mix the toner base particle and the toner external additive particles while stirring them is mentioned.

### Example

The present disclosure will more specifically described below using an Example. However, the present disclosure is not limited at all to the scope of the Example. In the Example, the longitudinal direction of an A4 size print sheet may be referred to as “vertical”, and the lateral direction thereof may be referred to as “lateral”.

### [Measurement of Saturation Magnetization and Coercivity]

In the present Example, the saturation magnetization and the coercivity of a carrier core were measured using a high-sensitivity vibrating sample magnetometer (“VSM-P7” made by Toei Industry Co., Ltd.) in an applied magnetic field of 3000 Oe.

### [Surface Roughness of Photosensitive Member]

The surface roughness Ra of a photosensitive member was measured by the method according to JIS (Japanese Industrial Standards) B0601 (Geometrical Product Specifications (GPS)—Surface Texture: Profile Method—Terms, Definitions And Surface Texture Parameters).

### [Measurement of Number Average Primary Particle Diameter]

The number average primary particle diameter of particles was measured using a scanning electron microscope (field emission scanning electron microscope, “JSM-7600F” made by JEOL Ltd.). In the measurement of the number average primary particle diameter, the circle-equivalent diameters (Heywood diameter: the diameter of a circle having the same area as the projected area of a primary particle) of 100 primary particles were measured, and the number average value thereof was determined.

### [Measurement of Coverage Ratio]

The coverage ratio of a spacer particle in a toner particle and the coverage ratio of a carrier external additive in a carrier particle were measured by the following method. A conductive tape was fixed to a SEM sample stage in a state where an adhesive surface was directed to a front side. On the adhesive surface of the conductive tape, a measurement target (the toner particles or the carrier particles) were scattered. Then, an excess measurement target was removed from the adhesive surface by air blowing. Then, the adhesive surface was covered with drug-wrapping paper, and the measurement target was fixed to the conductive tape by applying a load to the measurement target through the drug-wrapping paper. Then, the drug-wrapping paper was peeled off from the adhesive surface of the conductive tape. In this way, a sample was obtained which included the conductive tape and the measurement target dispersed and fixed on the adhesive surface of the conductive tape. The field emission scanning electron microscope (FE-SEM, “JSM-7600F” made by JEOL Ltd.) was used to capture a reflected electron image (captured surface image) on the surface of the measurement target in the obtained sample. The setting conditions of the FE-SEM were as follows.

### (Setting Conditions of FE-SEM for Measurement of Coverage Ratio)

Acceleration voltage of electron beams during capturing: 1 kV
Measurement mode: BE mode (mode in which reflected electron signals were mainly measured)
Magnification: 500 times
Emission current: 10 pA
Applied current: 450 pA
Capturing mode: integration totalization (256 times)

### (Image Analysis)

The obtained image (captured surface image of the measurement target) was analyzed using image analysis software (“WinROOF” made by MITANI CORPORATION). In the measurement, 10 particles were randomly selected from the measurement target. Then, the coverage ratio A in each of the particles (the coverage ratio of the spacer particle in the toner particle or the coverage ratio of the carrier external additive in the carrier particle) was measured. Then, the arithmetic average value of the measured coverage ratios A of the 10 particles was used as the coverage ratio in the measurement target.

### (Synthesis of Amorphous Polyester Resin)

A 5 L reaction container having a thermometer (thermocouple), a dehydration tube, a nitrogen inlet tube and a stirring device (stirring blade) was set in an oil bath. Into this reaction container, 1575 g of BPA-PO (bisphenol A propylene oxide adduct), 163 g of BPA-EO (bisphenol A ethylene oxide adduct), 377 g of fumaric acid and 4 g of a catalyst (dibutyltin oxide) were put. Then, after the interior of the reaction container was filled with nitrogen, the temperature inside the reaction container was increased to 220° C. using the oil bath while the contents were being stirred.

Under conditions of the nitrogen atmosphere and the temperature of 220° C., while by-product water was being distilled off, the contents of the reaction container were subjected to a polymerization reaction for 8 hours. Then, after reducing the pressure inside the reaction container, under conditions of the reduced pressure atmosphere (pressure: 8 kPa) and the temperature of 220° C., the contents of the reaction solution were subjected to a polymerization reaction for an additional hour. Then, after lowering the temperature inside the reaction container to 210° C., 336 g of trimellitic anhydride was added into the reaction container. Then, under conditions of the reduced pressure atmosphere (pressure: 8 kPa) and a temperature of 210° C., the contents of the reaction container were reacted. A reaction time in the reaction was adjusted such that the physical property values of the reaction product (amorphous polyester resin) were the following physical properties A. Thereafter, the reaction product was removed from the reaction container and was cooled to obtain an amorphous polyester resin having the physical properties A.

Physical properties A: softening point (Tm) of 100° C., glass transition point (Tg) of 50° C., mass average molecular weight (Mw) of 30,000, acid value of 15 mg KOH/g and hydroxyl value of 30 mg KOH/g.

### (Preparation of Toner Base Particle)

An FM mixer (“FM-10B” made by NIPPON COKE & ENGINEERING CO., LTD.) was used to mix 100 parts by mass of a binding resin, 4 parts by mass of a colorant, 1 part by mass of a charge control agent and 5 parts by mass of a mold release agent. As the binding resin, 100 parts by mass of the above amorphous polyester resin (Tm: 100° C., Tg: 50° C.) was used. As the colorant, a copper phthalocyanine blue pigment (C.I. Pigment Blue 15:3) was used. As the charge control agent, a quaternary ammonium salt (“BONTRON (registered trademark) P-51” made by ORIENT CHEMICAL INDUSTRIES CO., LTD.) was used. As the mold release agent, carnauba wax (“Special Carnauba Wax No. 1” made by S. KATO & CO.) was used.

The resulting mixture was melt-kneaded using a twin-screw extruder (“PCM-30 Model” made by Ikegai Corp.). The resulting melt-kneaded mixture was pulverized using a mechanical pulverizer (“Turbo Mill” made by FREUND-TURBO CORPORATION). The resulting pulverized material was classified using a classifier (“Elbow Jet” made by Nittetsu Mining Co., Ltd.). In this way, powdered toner base particles having a volume median diameter (D50) of 6.8 μm were obtained.

### [Preparation of Resin Particles]

Resin particles (R-A) to (R-E) were prepared by the following method.

### (Resin Particle (R-D))

A glass reaction container having a thermometer (thermocouple), a stirring device, a reflux condenser and a nitrogen inlet tube was set in a water bath (set temperature: 80° C.). Into this reaction container, 300.0 parts by mass of ion-exchanged water and 1.0 part by mass of di-t-butyl peroxide were put. Then, the interior of the reaction container was filled with nitrogen gas. In the subsequent operations, the temperature of the contents of the reaction container was kept at 80° C., and the interior of the reaction container was kept under the nitrogen gas atmosphere. Then, while the reaction container was being stirred, 0.2 parts by mass of ammonium persulfate and 60.0 parts by mass of a monomer mixture were dropped into the reaction container over a period of 1 hour. The monomer mixture was a mixture of 20 mol % of styrene, 40 mol % of butyl methacrylate and 40 mol % of divinylbenzene. Then, the contents were reacted while the reaction solution was being stirred. In this reaction, a reaction temperature (hereinafter also referred to as a “temperature X”) was set to 100° C., a reaction time (hereinafter also referred to as a “time Y”) was set to 4 hours and a stirring speed (hereinafter also referred to as a “speed Z”) was set to 756 rpm. The reaction solution (emulsion solution) after the reaction was dried, and thus crosslinked resin particles (number average primary particle diameter: 100 nm) were obtained. These crosslinked resin particles were used as the resin particles (R-D).

### (Resin Particles (R-A) to (R-C) and (R-E))

Crosslinked resin particles (resin particles (R-A) to (R-C) and (R-E)) having number average primary particle diameters of 40 nm, 60 nm, 80 nm and 115 nm were prepared by the same method as in the preparation of the above resin particle (R-D) except that the temperature X, the time Y and the speed Z were changed as shown in Table 1. In Table 1, the “particle diameter” indicates the number average primary particle diameter.

Table 1 is as follows.

TABLE 1

| Resin particle | | R-A | R-B | R-C | R-D | R-E |
|---|---|---|---|---|---|---|
| Monomer | Styrene [mass %] | 20 | 20 | 20 | 20 | 20 |
| | Butyl methacrylate | 40 | 40 | 40 | 40 | 40 |
| | [mass %] | | | | | |
| | Divinylbenzene | 40 | 40 | 40 | 40 | 40 |
| | [mass %] | | | | | |
| Conditions | Temperature [° C.] | 100 | 100 | 100 | 100 | 100 |
| | Time [hr] | 3 | 4 | 4 | 4 | 5 |
| | Speed [rpm] | 1160 | 1050 | 900 | 756 | 700 |

| | | | | | |
|---|---|---|---|---|---|
| Particle diameter [nm] | 40 | 60 | 80 | 100 | 115 |

### [Silica Particles]

Finely pulverized silica, carbon powder serving as a reducing agent and an appropriate amount of water were put into a container and were mixed, and thus a mixed raw material was obtained. Then, the mixed raw material was heated to about 1800° C. in an incinerator to generate SiO₂ gas. Then, the generated SiO₂ gas was forcibly cooled with cooling air (flow rate X: 80 m³/hour), and thus silica fine particles were precipitated. Then, the precipitated silica fine particles were collected using a bag filter. Then, aminopropylethoxysilane and silicone oil were added to the collected silica fine particles. Then, the silica fine particles after the addition were subjected to heat treatment, and thus a solid product was obtained. Then, the obtained solid product was pulverized using the FM mixer, and thus silica particles (Si-B) having a number average primary particle diameter of 100 nm were obtained.

Silica particles (Si-A) were prepared by the same method as in the preparation of silica particles B except that the flow rate X of the cooling air was changed as shown in Table 2 below.

Table 2 is as follows.

TABLE 2

| | Cooling air | Number average |
|---|---|---|
| | flow rate X | primary particle |
| Silica particle | [m³/hour] | diameter [nm] |
| Si-A | 140 | 40 |
| Si-B | 80 | 100 |

### [Preparation of Toners]

### (Toner (T-1))

100.00 parts by mass of the toner base particles described above, 1.50 parts by mass of base silica particles, 1.45 parts by mass of the spacer particles, 0.75 parts by mass of aluminum oxide particles and 0.5 parts by mass of strontium titanate particles were mixed using the FM mixer (“FM-10B” made by NIPPON COKE & ENGINEERING CO., LTD.) at 4,000 rpm for 5 minutes. The resulting mixture was sieved using a 200 mesh (opening of 75 μm) sieve, and thus a toner (T-1) was obtained. As the base silica particles, “AEROSIL (registered trademark) REA90” made by NIPPON AEROSIL CO., LTD. (fumed silica to which positive charging and hydrophobicity were provided by surface treatment and which had a number average primary particle diameter of 20 nm) was used. As the spacer particle, the resin particle (R-E) described above (number average primary particle diameter: 115 nm) was used. The strontium titanate particles were undoped strontium titanate particles (“SW-100” made by Titan Kogyo, Ltd.) the particle size of which was adjusted (number average primary particle size: 30 nm). As the aluminum oxide particles, “AEROXIDE (registered trademark) Alu C805” (BET specific surface area: 75 to 105 m²/g, number average primary particle diameter: 13 nm) made by NIPPON AEROSIL CO., LTD was used.

### (Toners (T-2) to (T-8))

Toners (T-2) to (T-9) were prepared by the same method as in the preparation of the toner (T-1) except that the type and the amount of spacer particle used were changed as shown in Table 3 below. In Table 3 below, the coverage ratio of the spacer particle in the toner particle is also shown. In Table 3 below, the “particle diameter” indicates the number average primary particle diameter of the spacer particles.

Table 3 is as follows.

TABLE 3

| | | Spacer particle | | | |
|---|---|---|---|---|---|
| | Toner base | | | Coverage | Particle |
| | particle | | | ratio | diameter |
| Type | [mass part] | Type | Mass part | [area %] | [nm] |
| T-1 | 100.0 | R-E | 1.45 | 25 | 115 |
| T-2 | 100.0 | R-C | 1.01 | 25 | 80 |
| T-3 | 100.0 | R-B | 0.76 | 25 | 60 |
| T-4 | 100.0 | R-A | 0.50 | 25 | 40 |
| T-5 | 100.0 | R-D | 0.50 | 10 | 100 |
| T-6 | 100.0 | R-D | 1.26 | 25 | 100 |
| T-7 | 100.0 | R-D | 2.01 | 40 | 100 |
| T-8 | 100.0 | Si-B | 2.77 | 25 | 100 |
| T-9 | 100.0 | Si-A | 1.11 | 25 | 40 |

### [Preparation of Carriers]

Carriers (C-1) to (C-6) were prepared by the following method.

### (Preparation of Carrier (C-1))

361.2 g of a silicone resin solution (“KR-255” made by Shin-Etsu Chemical Co., Ltd., solid content concentration: 50% by mass, solid content: 180.6 g), 36.2 g of barium titanate (“BT-03” made by Sakai Chemical Industry Co., Ltd., barium titanate manufactured by a hydrothermal synthesis method, number average primary particle diameter: 304 nm), 14.4 g of carbon black (“Ketjen Black EC-300J” made by Lion Specialty Chemicals Co., Ltd.) and 1444.8 g of toluene were mixed using a homomixer to obtain a coat solution.

A fluidized bed coating device (“FD-MP-01 D Model” made by Powrex Corporation) was used to spray the coat solution to a carrier core while 5000 g of the carrier core was being fluidized. In this way, the carrier core coated with the coat solution was obtained. The amount of coat solution used was set such that the mass of a coat layer was 1.5 parts by mass (that is, the solid content was 75 g) with respect to 100.0 parts by mass of the carrier core. The coating conditions were as follows: a supply air temperature (corresponding to a predetermined drying temperature described in the embodiment) was 75° C., a supply air amount was 0.3 m³/minute and a rotor rotation speed was 400 rpm. As the carrier core, a manganese ferrite core (made by DOWA IP Creation Co., Ltd., volume median diameter: 40 μm, saturation magnetization: 67 emu/g) was used. The carrier core coated with the coat solution was sintered in an electric furnace at a temperature of 200° C. for 1 hour. In this way, the coat layer was formed on the surface of the carrier core, and thus carrier base particles were obtained.

100.00 parts by mass of the above carrier base particles and 0.04 parts by mass of strontium titanate particles (carrier external additive) were mixed using a Rocking Mixer (registered trademark) (“RM-10” made by AICHI ELECTRIC CO., LTD.) for 30 minutes, and thus the strontium titanate particles were adhered to the surfaces of the carrier base particles. As the strontium titanate particles, undoped strontium titanate (“SW-100” made by Titan Kogyo, Ltd.) the particle size of which was adjusted to a number average primary particle size of 30 nm was used. In this way, the carrier (C-1) was obtained.

### (Preparation of Carriers (C-2) to (C-6))

The carriers (C-2) to (C-6) were prepared by the same method as in the preparation of the carrier (C-1) except that the amount and the number average primary particle diameter of strontium titanate particles (carrier external additive) used were changed as shown in Table 4 below. In Table 4 below, the coverage ratio of the carrier external additive particle in the carrier particle is also shown. In Table 4 below, the “particle diameter” indicates the number average primary particle diameter of the strontium titanate particles (carrier external additive).

The strontium titanate particles used in the preparation of the carriers (C-2) to (C-5) were the undoped strontium titanate (“SW-100” made by Titan Kogyo, Ltd. the particle size of which was adjusted). In the preparation of the carrier (C-6), external addition of the strontium titanate particles (carrier external additive) was not performed.

Table 4 is as follows.

TABLE 4

| | | Carrier external additive | | |
|---|---|---|---|---|
| | | | Coverage | Particle |
| | Carrier base particle | | ratio | diameter |
| | Mass part | Mass part | [area %] | [nm] |
| C-1 | 100.00 | 0.04 | 14.1 | 30 |
| C-2 | 100.00 | 0.02 | 7.1 | 30 |
| C-3 | 100.00 | 0.09 | 31.7 | 30 |
| C-4 | 100.00 | 0.07 | 14.1 | 50 |
| C-5 | 100.00 | 0.11 | 14.1 | 80 |
| C-6 | 100.00 | — | — | — |

### <Preparation of Two-Component Developers>

### (Developer (D-1))

A shaker mixer (“Turbler (registered trademark) Mixer T2F” made by Willy et Bacoffen (WAB)) was used to mix 8 parts by mass of the toner (T-1) and 100 parts by mass of the carrier (C-1) for 30 minutes. In this way, a developer (D-1) (toner ratio: 8%) which was an initial developer was obtained.

The shaker mixer (“Turbler (registered trademark) Mixer T2F” made by Willy et Bacoffen (WAB)) was used to mix 100 parts by mass of the toner described above and 10 parts by mass of the carrier described above for 30 minutes. In this way, a replenishment developer corresponding to the developer (D-1) was obtained.

### (Developers (D-2) to (D-15))

Developers (D-2) to (D-15) and replenishment developers corresponding to the developers (D-2) to (D-15) were obtained by the same method as in the preparation of the developer (D-1) except the types of toner and carrier were changed as shown in Table 5 below.

Table 5 is as follows.

TABLE 5

| Developer | Toner | Carrier |
|---|---|---|
| D-1 | T-1 | C-1 |
| D-2 | T-2 | C-1 |
| D-3 | T-3 | C-1 |
| D-4 | T-4 | C-1 |
| D-5 | T-5 | C-1 |
| D-6 | T-6 | C-1 |
| D-7 | T-7 | C-1 |
| D-8 | T-6 | C-4 |
| D-9 | T-6 | C-5 |
| D-10 | T-6 | C-2 |
| D-11 | T-6 | C-3 |
| D-12 | T-6 | C-5 |
| D-13 | T-8 | C-1 |
| D-14 | T-9 | C-1 |
| D-15 | T-6 | C-6 |

### [Intermediate Transfer Belts]

Intermediate transfer belts A to D shown in Table 6 were prepared.

### (Intermediate Transfer Belt A)

A polyamic acid solution (“U-Varnish” made by UBE Corporation, 100 parts by mass of solid content) and 20 parts by mass of carbon black (“MA-100R” made by Mitsubishi Chemical Group Corporation with a number average primary particle diameter of 24 nm) were mixed, and thus an intermediate transfer belt formation solution was obtained. The intermediate transfer belt formation solution was subjected to centrifugal molding to form a belt shape, and the polyamic acid was imidized. In this way, an intermediate transfer belt A (base resin: polyimide, conductive agent: carbon black) was obtained.

### (Intermediate Transfer Belt B)

100 parts by mass of polyamide 12 (“UBESTA (registered trademark) 3030U” made by UBE Corporation) and 15 parts by mass of carbon black (“MA-100R” made by Mitsubishi Chemical Group Corporation with a number average primary particle diameter of 24 nm) were mixed, and thus an intermediate transfer belt formation material was obtained. The intermediate transfer belt formation material was subjected to extrusion molding to form a belt shape. In this way, an intermediate transfer belt B (base resin: polyimide 12, conductive agent: carbon black) was obtained.

### (Intermediate Transfer Belt C)

100 parts by mass of PVDF (Kynar (registered trademark) 741 made by ARKEMA K.K.) and 60 parts by mass of titanium oxide particles (“FTL-200” made by ISHIHARA SANGYO KAISHA, LTD.) were mixed, and thus an intermediate transfer belt formation material was obtained. The intermediate transfer belt formation material was subjected to extrusion molding to form a belt shape. In this way, an intermediate transfer belt C (base resin: PVDF, conductive agent: particles of titanium oxide) was obtained.

### (Intermediate Transfer Belt D)

100 parts by mass of polyethylene terephthalate (“TR-8550” made by TEIJIN LIMITED) and 20 parts by mass of polyether ester amide (“Pelestat (registered trademark) NC6321” made by Sanyo Chemical Industries, Ltd.) were mixed, and thus an intermediate transfer belt formation material was obtained. The intermediate transfer belt formation material was subjected to extrusion molding to form a belt shape. In this way, an intermediate transfer belt D (base resin: polyethylene terephthalate, conductive agent: polyether ester amide) was obtained.

Table 6 is as follows.

TABLE 6

| Inter- | | | | | |
|---|---|---|---|---|---|
| mediate | Base resin | | Conductive agent | | Manu- |
| transfer | | Mass | | Mass | facturing |
| belt | Type | part | Type | part | method |
| A | Thermosetting | 100 | Electronic | 20 | Centrifugal |
| | resin | | conductive | | molding |
| | (polyimide) | | agent | | |
| | | | (carbon | | |
| | | | black) | | |
| B | Thermoplastic | 100 | Electronic | 15 | Extrusion |
| | resin | | conductive | | molding |
| | (polyamide | | agent | | |
| | 12) | | (carbon | | |
| | | | black) | | |
| C | Thermoplastic | 100 | Electronic | 60 | Extrusion |
| | resin | | conductive | | molding |
| | (PVDF) | | agent | | |
| | | | (particles of | | |
| | | | titanium | | |
| | | | oxide) | | |
| D | Thermoplastic | 100 | Ionic | 20 | Extrusion |
| | resin | | conductive | | molding |
| | (PET) | | agent | | |
| | | | (polyether | | |
| | | | ester amide) | | |

### [Photosensitive Members]

A mirror-finished aluminum raw tube (diameter: 30 mm) was subjected to wet blasting treatment, and thus a surface-roughened aluminum raw tube was obtained. Then, an amorphous silicon photosensitive layer (thickness: 21 μm) was formed on the surface of the surface-roughened aluminum raw tube by vapor deposition of silane gas. In this way, photosensitive members (P-1) to (P-5) were obtained. In the manufacturing of the photosensitive members (P-1) to (P-5), the conditions of the wet blasting treatment were changed as necessary, and thus the arithmetic average roughness Ra of the surface was adjusted to be as shown in Table 7 below.

Table 7 is as follows.

TABLE 7

| Photosensitive member | P-1 | P-2 | P-3 | P-4 | P-5 |
|---|---|---|---|---|---|
| Ra[nm] | 34 | 40 | 68 | 100 | 110 |

### [Image Forming Apparatus]

A color multifunctional peripheral of a trickle development system (“TASKalfa7054ci” made by Kyocera Document Solutions Inc.) was prepared. The color multifunctional peripheral mainly included an amorphous silicon drum serving as a photosensitive member, a development device of a two-component development system, an intermediate transfer belt and a cleaning blade. The maximum printing speed of the color multifunctional peripheral described above was 70 sheets per minute. A development gap in the color multifunctional peripheral was 0.375 mm. When the color multifunctional peripheral printed an A4 size print sheet, the printing was performed such that the width direction of the print sheet coincides with the direction of the printing.

The photosensitive member was removed from the color multifunctional peripheral, and any of the photosensitive members (P-1) to (P-5) was fitted instead. The intermediate transfer belt was removed from the color multifunctional peripheral, and any of the intermediate transfer belts A to D was fitted instead. Furthermore, any of the developers (D-1) to (D-15) was put into a cyan development device in the color multifunctional peripheral. Furthermore, the replenishment developer corresponding to each of the developers was put into the replenishment unit of the cyan development device in the color multifunctional peripheral. In this way, image forming apparatuses Nos. 1 to 21 were obtained as shown in Tables 8 to 12 below.

For example, the image forming apparatus No. 1 included the photosensitive member (P-4) (Ra: 100 nm) as the photosensitive member. The image forming apparatus No. 1 included the intermediate transfer belt A as the intermediate transfer belt. The image forming apparatus No. 1 included the developer (D-1) as the initial developer. The image forming apparatus No. 1 included the replenishment developer corresponding to the developer (D-1) as the replenishment developer.

Voltage settings for the image forming apparatuses Nos. 1 to 21 were made as follows.
Development bias (alternating-current component) V_{ac}: 1300 to 900 V
Development bias (direct-current component) V_{d}: 90 to 280 V
Setting surface potential of photosensitive member (surface potential of non-printing portion) V₀: 160 to 350 V (settings were made such that “V₀−V_{dc}=70 V”)
Surface potential of printing portion in photosensitive member: 10 V

Table 8 is as follows.

TABLE 8

| No. | | | | 1 | 2 | 3 | 4 | 5 |
|---|---|---|---|---|---|---|---|---|
| Devel- | Type | | | D-1 | D-2 | D-1 | D-3 | D-3 |
| oper | Toner | Type | | T-1 | T-2 | T-1 | T-3 | T-3 |
| | | Spacer | Material | Resin | Resin | Resin | Resin | Resin |
| | | particle | Coverage | 25 | 25 | 25 | 25 | 25 |
| | | | ratio [%] | | | | | |
| | | | Diameter | 115 | 80 | 115 | 60 | 60 |
| | | | [nm] | | | | | |
| | Carri- | Type | | C-1 | C-1 | C-1 | C-1 | C-1 |
| | er | Carrier | Coverage | 14.1 | 14.1 | 14.1 | 14.1 | 14.1 |
| | | external | ratio [%] | | | | | |
| | | additive | Diameter | 30 | 30 | 30 | 30 | 30 |
| | | | [nm] | | | | | |

| | | | | | |
|---|---|---|---|---|---|
| Photosensitive member Ra [nm] | 100 | 100 | 110 | 40 | 34 |
| Intermediate transfer belt | A | A | A | A | A |

Table 9 is as follows.

TABLE 9

| No. | | | 6 | 7 | 8 | 9 |
|---|---|---|---|---|---|---|
| Developer | Type | | D-4 | D-5 | D-6 | D-7 |
| | Toner | Type | T-4 | T-5 | T-6 | T-7 |

| | | | | | |
|---|---|---|---|---|---|
| Spacer | Material | Resin | Resin | Resin | Resin |
| particle | Coverage | 25 | 10 | 25 | 40 |
| | ratio [%] | | | | |
| | Diameter | 40 | 100 | 100 | 100 |
| | [nm] | | | | |

| | | | | | |
|---|---|---|---|---|---|
| Carrier | Type | C-1 | C-1 | C-1 | C-1 |

| | | | | | |
|---|---|---|---|---|---|
| Carrier | Coverage | 14.1 | 14.1 | 14.1 | 14.1 |
| external | ratio [%] | | | | |
| additive | Diameter | 30 | 30 | 30 | 30 |
| | [nm] | | | | |

| | | | | |
|---|---|---|---|---|
| Photosensitive member Ra [nm] | 68 | 68 | 68 | 68 |
| Intermediate transfer belt | A | A | A | A |

Table 10 is as follows.

TABLE 10

| No. | | | 10 | 11 | 12 | 13 |
|---|---|---|---|---|---|---|
| Developer | Type | | D-8 | D-9 | D-10 | D-11 |
| | Toner | Type | T-6 | T-6 | T-6 | T-6 |

| | | | | | |
|---|---|---|---|---|---|
| Spacer | Material | Resin | Resin | Resin | Resin |
| particle | Coverage | 25 | 25 | 25 | 25 |
| | ratio [%] | | | | |
| | Diameter | 100 | 100 | 100 | 100 |
| | [nm] | | | | |

| | | | | | |
|---|---|---|---|---|---|
| Carrier | Type | C-4 | C-5 | C-2 | C-3 |

| | | | | | |
|---|---|---|---|---|---|
| Carrier | Coverage | 14.1 | 14.1 | 7.1 | 31.7 |
| external | ratio [%] | | | | |
| additive | Diameter | 50 | 80 | 30 | 30 |
| | [nm] | | | | |

| | | | | |
|---|---|---|---|---|
| Photosensitive member Ra [nm] | 68 | 68 | 68 | 68 |
| Intermediate transfer belt | A | A | A | A |

Table 11 is as follows.

TABLE 11

| No. | | | 14 | 15 | 16 | 17 |
|---|---|---|---|---|---|---|
| Developer | Type | | D-12 | D-6 | D-13 | D-14 |
| | Toner | Type | T-6 | T-6 | T-8 | T-9 |

| | | | | | |
|---|---|---|---|---|---|
| Spacer | Material | Resin | Resin | Resin | Silica |
| particle | Coverage | 25 | 25 | 25 | 25 |
| | ratio [%] | | | | |
| | Diameter | 100 | 100 | 100 | 40 |
| | [nm] | | | | |

| | | | | | |
|---|---|---|---|---|---|
| Carrier | Type | C-5 | C-1 | C-1 | C-1 |

| | | | | | |
|---|---|---|---|---|---|
| Carrier | Coverage | 14.1 | 14.1 | 14.1 | 14.1 |
| external | ratio [%] | | | | |
| additive | Diameter | 80 | 30 | 30 | 30 |
| | [nm] | | | | |

| | | | | |
|---|---|---|---|---|
| Photosensitive member Ra [nm] | 100 | 40 | 68 | 68 |
| Intermediate transfer belt | A | A | A | A |

Table 12 is as follows.

TABLE 12

| No. | | | 18 | 19 | 20 | 21 |
|---|---|---|---|---|---|---|
| Developer | Type | | D-6 | D-6 | D-6 | D-15 |
| | Toner | Type | T-6 | T-6 | T-6 | T-6 |

| | | | | | |
|---|---|---|---|---|---|
| Spacer | Material | Resin | Resin | Resin | Resin |
| particle | Coverage | 25 | 25 | 25 | 25 |
| | ratio [%] | | | | |
| | Diameter | 100 | 100 | 100 | 100 |
| | [nm] | | | | |

| | | | | | |
|---|---|---|---|---|---|
| Carrier | Type | C-1 | C-1 | C-1 | C-6 |

| | | | | | |
|---|---|---|---|---|---|
| Carrier | Coverage | 14.1 | 14.1 | 14.1 | — |
| external | ratio [%] | | | | |
| additive | Diameter | 30 | 30 | 30 | — |
| | [nm] | | | | |

| | | | | |
|---|---|---|---|---|
| Photosensitive member Ra [nm] | 68 | 68 | 68 | 68 |
| Intermediate transfer belt | B | C | D | A |

### <Evaluations>

The image forming apparatuses Nos. 1 to 21 were evaluated for white spot suppression performance and the suppression of contamination of charging rollers and photosensitive members by the following method. The evaluation results are shown in Tables 13 to 17. Unless otherwise specified, the evaluations were performed in a low temperature and low humidity environment (at a temperature of 10° C. and at a humidity of 15% RH).

### [Optimization of V_{ac}]

Calibration of V_{ac} was performed on the image forming apparatuses Nos. 1 to 21, and thus V_{ac} was optimized.

### [Measurement of Appropriate Voltage of V_{dc}]

While V_{dc} was being changed in the image forming apparatuses Nos. 1 to 21, a plurality of solid images were formed. Specifically, in a state where V_{dc} was set to a predetermined value (for example, 90 V), the first solid image was printed on a print sheet. Here, before the solid image was transferred to the print sheet, the image density of a toner image (unfixed toner image corresponding to the solid image) transferred on the intermediate transfer belt was measured by the following method. Then, V_{dc} was increased or decreased with reference to the measured image density of the toner image (as V_{dc} was increased, the image density of the toner image was increased). Then, the subsequent solid image was printed on a separate print sheet. By repeating this series of steps (printing the solid image on the print sheet, measuring the image density of the toner image transferred on the intermediate transfer belt and increasing or decreasing V_{dc}), the minimum value of V_{dc} capable of forming a toner image having a target image density (1.45) on the intermediate transfer belt was determined. The obtained minimum value was assumed to be the appropriate voltage of V_{dc} in the image forming apparatuses Nos. 1 to 21. The appropriate voltages of V_{dc} which were measured are shown in Tables 13 to 17 below. In the optimization of V_{ac}, V₀ was changed as V_{ac} was changed such that “V₀−V_{dc}=70 V” was maintained.

### (Measurement of Image Density of Solid Image on Intermediate Transfer Belt)

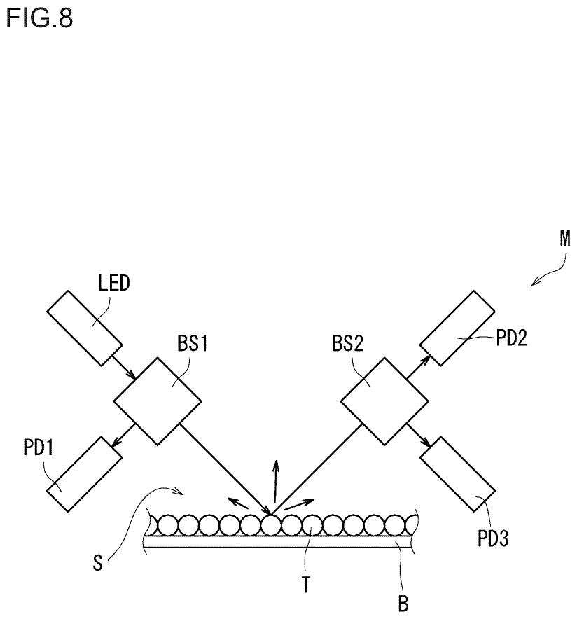

The image density of the solid image on the intermediate transfer belt was measured using a measuring device M shown in FIG. 8. In FIG. 8, on an intermediate transfer belt B, a toner image S corresponding to the solid image (collection of toners T transferred on the intermediate transfer belt B) was formed. The measuring device M shown in FIG. 8 was a reflective optical sensor. The measuring device M is a device which uses a near-infrared light-emitting diode as a light-emitting element and a photodiode as a light-receiving element to detect the image density from specularly reflected light and diffusely reflected light.

Specifically, the measuring device M includes a light emitting unit LED, a first light receiving unit PD1, a second light receiving unit PD2 and a third light receiving unit PD3 (PD: Photo Detector), a first beam splitter BS1 and a second beam splitter BS2 (BS: Beam Splitter). The light emitting unit LED applies application light toward the first beam splitter BS1. The application light applied from the light emitting unit LED is split by the first beam splitter BS1 into a component (s-wave light) which vibrates in a vertical direction with respect to an incident surface and a component (p-wave light) which vibrates parallel to the incident surface. Then, the first beam splitter BS1 applies the s-wave light to the first light receiving unit PD1 provided in the vicinity of the light emitting unit LED, and applies the p-wave light to the intermediate transfer belt B.

As shown in FIG. 8, the p-wave light applied to the toners T on the intermediate transfer belt B is diffusely reflected, and thus a part thereof forms an s wave. In other words, the p-wave light applied to the toners T is separated into the reflected light of the p wave and the reflected light of the s wave. The reflected light of the p wave enters the second light receiving unit PD2 via the second beam splitter BS2, and is detected as the “specularly reflected light amount”. On the other hand, the reflected light of the s wave enters the third light receiving unit PD3 via the second beam splitter BS2, and is detected as the “diffusely reflected light amount”. Hence, the second light receiving unit PD2 functions as a specularly reflected light amount detection means, and the third light receiving unit PD3 functions as a diffusely reflected light amount detection means.

In actuality, it is assumed that a diffusely reflected component also enters the second light receiving unit PD2. Hence, a “value obtained by multiplying the output of the s wave detected with the third light receiving unit PD3 by a correction coefficient” is subtracted from the “output of the p wave detected with the second light receiving unit PD2”, and thus a true specular reflection output (sensor output) is obtained (formula below). As the correction coefficient, a predetermined value is used.

sensor output={specularly reflected light amount (p wave) output}−{diffusely reflected light amount (s wave) output}×correction coefficient

In FIG. 8, the p-wave light is applied to a region (image region) where the toners T are transferred in the intermediate transfer belt B. On the other hand, when the p-wave light is applied to a region (non-image region) where the toners T are not transferred in the intermediate transfer belt B, the p-wave light is almost specularly reflected to enter the second beam splitter BS2 as specularly reflected light (p wave). Then, the specularly reflected light which has entered the second beam splitter BS2 enters the second light receiving unit PD2.

In the present measurement, a relational formula is previously formed based on a relationship between a solid image having a known image density and the sensor output. Then, based on the actually measured sensor output and the relational formula, the image density of the toner image S on the intermediate transfer belt B can be calculated.

### [White Spots]

In the image forming apparatuses Nos. 1 to 21, V_{dc} was set to the minimum value (90 V). Then, the image forming apparatuses Nos. 1 to 21 were used to print a stripe image, a solid image and a checker image on three A4 size print sheets, respectively. When each of the images was printed, whether white spots (in general, about 1.5 mm horizontally and 0.5 mm vertically) were generated on a toner image transferred on the intermediate transfer belt was detected using the measuring device M shown in FIG. 8. Specifically, the measuring device M can measure an image density within a circular measurement spot having a diameter of 3 mm at a time. In the detection of white spots, the measuring device M was used to measure the image density of the toner image on the intermediate transfer belt while displacing the measurement spot serving as a detection target by 0.7 mm (0.7 mm pitch). Then, when the image density measured at a specific spot was equal to or less than a certain value or when the image density of the specific spot was equal to or greater than a certain value as compared with the image density of a spot adjacent thereto, white spots were determined to be generated.

The stripe image described above was formed with a plurality of parallel horizontal lines (vertical: 0.1 mm, horizontal: 6 mm) (total of 56 lines with an interval between adjacent horizontal lines of 0.1 mm). The solid image described above was a vertical stripe-shaped solid image (horizontal: 6 cm, vertical: 8.6 cm). The checker image described above was formed with a square printing portion (solid image) with sides of 0.5 mm and a square non-printing portion with sides of 0.5 mm (vertical: 6.5 mm, horizontal: 4.5 mm, total of 59 printing portions).

Then, after in the image forming apparatuses Nos. 1 to 21, V_{dc} was set 10 V higher, the three types of images (the stripe image, the solid image and the checker image) were likewise formed, and whether white spots were generated on the toner image transferred on the intermediate transfer belt was checked. This series of steps (setting V_{dc} 10 V higher, forming the three types of images and checking whether white spots were generated) was repeated, and thus the minimum value (generation voltage) of V_{dc} at which white spots were generated in each of the image forming apparatuses was measured.

The image forming apparatus cannot from an image having a desired image density unless V_{dc} is set equal to or greater than the appropriate voltage described previously. However, in the image forming apparatus, as V_{dc} is increased, white spots are easily generated. Here, in the image forming apparatus, when a margin voltage (generation voltage−appropriate voltage of V_{dc}) that is a difference between the appropriate voltage of V_{dc} and V_{dc} at which white spots are generated is sufficiently greater, the possibility of white spots generated during actual use is low (the generation of white spots can be suppressed). On the other hand, in the image forming apparatus, when the margin voltage is low or when the margin voltage is negative, there is a possibility that white spots are generated during actual use (the generation of white spots cannot be suppressed). Hence, the magnitude of the margin voltage was used as an index of whether the generation of white spots can be suppressed. Whether the generation of white spots can be suppressed was determined according to the following criteria.

### (Criteria for White Spots)

A (most satisfactory): margin voltage is equal to or greater than 31V
B (particularly satisfactory): margin voltage is equal to or greater than 11V but equal to or less than 30 V
C (satisfactory): margin voltage is equal to or greater than 1V but equal to or less than 10 V
D (unsatisfactory): margin voltage is less than 0 V

### [Charging Roller Contamination (1K)]

In each of the image forming apparatuses, V_{dc} was set to the appropriate voltage shown in Tables 13 to 17. Then, each of the image forming apparatuses was used to continuously print a pattern image formed with a solid image of three horizontal stripes on 1000 A4 size print sheets (printing durability test). In the solid image described above, the three horizontal stripes were 2 mm, 4 mm and 8 mm long, respectively, and the horizontal length was the upper limit of a printable range on the print sheet. Then, the photosensitive member in each of the image forming apparatuses was replaced with a new photosensitive member (any one of photosensitive members (P-1) to (P-5) having Ra shown in Tables 8 to 10). Then, a halftone image (hereinafter also referred to as an evaluation image) was printed on one A4 size print sheet. Then, the evaluation image was visually observed, and thus whether an image failure caused by contamination of the charging roller occurred was checked. When the charging roller is contaminated, a part where the image density is lowered is generated in the halftone image. Whether the charging roller was contaminated was determined according to the following criteria. The results were used as the results of the evaluation of the “charging roller contamination (1K)”.

### (Criteria for Charging Roller Contamination (1K))

A (particularly satisfactory): part where image density was lowered was not generated in halftone image
B (satisfactory): part where image density was slightly lowered was generated in halftone image
C (unsatisfactory): part where image density was obviously lowered was generated in halftone image

### [Charging Roller Contamination (10K)]

In each of the image forming apparatuses, V_{dc} was set to the appropriate voltage shown in Tables 13 to 17. Then, each of the image forming apparatuses was used to continuously print the above pattern image formed with the solid image of the three horizontal stripes on 1000 A4 size print sheets (first printing durability test). Then, V_{ac} and V_{dc} in each of the image forming apparatuses were adjusted, and thus a state was achieved where the pattern image having the same image density as before the first printing durability test was able to be printed (adjustment step). Then, each of the image forming apparatuses was used to continuously print the above pattern image on 1000 A4 size print sheets (second printing durability test). The adjustment step and the second printing durability test were repeated a total of nine times. Specifically, a total of 10000 pattern images were printed by combining the first printing durability test (1000 sheets printed) and the nine second printing durability tests (total of 9000 sheets printed).

Then, the photosensitive member in each of the image forming apparatuses was replaced with a new photosensitive member (any one of the photosensitive members (P-1) to (P-5) having Ra shown in Tables 8 to 10). Then, a halftone image (hereinafter also referred to as an evaluation image) was printed on one A4 size print sheet. Then, the evaluation image was visually observed, and thus whether an image failure caused by contamination of the charging roller occurred was checked. When the charging roller is contaminated, a part where the image density is lowered is generated in the halftone image. Whether the charging roller was contaminated was determined according to the following criteria. The results were used as the results of the evaluation of the “charging roller contamination (10K)”.

### (Criteria for Charging Roller Contamination (10K))

A (particularly satisfactory): part where image density was lowered was not generated in halftone image
B (satisfactory): part where image density was slightly lowered was generated in halftone image
C (unsatisfactory): part where image density was obviously lowered was generated in halftone image

### [Photosensitive Member Contamination]

A total of 10000 pattern images were printed by the same method as in the evaluation of the charging roller contamination (10K). Thereafter, the photosensitive member was not replaced with a new photosensitive member, and a halftone image (hereinafter also referred to as an evaluation image) was printed on one A4 size print sheet. The evaluation image was visually observed, and thus whether the photosensitive member was contaminated by a toner external additive was checked. When the photosensitive member is contaminated, an image loss is caused in the halftone image. Whether the photosensitive member was contaminated was determined according to the following criteria. The results were used as the results of the evaluation of “photosensitive member contamination”.

### (Criteria for Photosensitive Member Contamination)

A (particularly satisfactory): no image loss occurred in halftone image
B (satisfactory): slight image loss occurred in halftone image
C (unsatisfactory): obvious image loss occurred in halftone image

### [Overall Evaluation]

An overall evaluation was performed on each of the image forming apparatuses according to the following criteria.
A (particularly satisfactory): evaluation for white spots was A or B, and evaluations for charging roller contamination (1K), charging roller contamination (10K) and photosensitive member contamination were all As
B (satisfactory): overall evaluation was not A, and “unsatisfactory” evaluation result was not received
C (unsatisfactory): “unsatisfactory” evaluation result was received

Table 13 is as follows.

TABLE 13

| No. | | 1 | 2 | 3 | 4 | 5 |
|---|---|---|---|---|---|---|
| Manufac- | Appropriate voltage [V] | 117 | 124 | 117 | 125 | 125 |
| turing | Generation voltage [V] | 140 | 120 | 140 | 130 | 130 |
| method | Margin voltage [V] | 23 | −4 | 23 | 5 | 5 |
| for sup- | Determination | B | D | B | C | C |
| pression | | | | | | |
| of white | | | | | | |
| spots | | | | | | |
| Photosensitive member contamination | | A | A | A | A | A |
| Charging | 1K | A | A | C | A | A |
| roller con- | 10K | A | A | C | A | C |
| tamination | | | | | | |

| | | | | | |
|---|---|---|---|---|---|
| Overall evaluation | A | C | C | B | C |

Table 14 is as follows.

TABLE 14

| No. | | 6 | 7 | 8 | 9 |
|---|---|---|---|---|---|
| Manufacturing | Appropriate voltage [V] | 127 | 119 | 120 | 119 |
| method for | Generation voltage [V] | 120 | 140 | 140 | 130 |
| suppression of | Margin voltage [V] | −7 | 21 | 20 | 21 |
| white spots | Determination | D | B | B | B |
| Photosensitive member contamination | | A | A | A | A |
| Charging roller | 1K | A | A | A | A |
| contamination | 10K | A | A | A | A |

| | | | | |
|---|---|---|---|---|
| Overall evaluation | C | A | A | A |

Table 15 is as follows.

TABLE 15

| No. | | 10 | 11 | 12 | 13 |
|---|---|---|---|---|---|
| Manufacturing | Appropriate voltage [V] | 118 | 118 | 122 | 118 |
| method for | Generation voltage [V] | 140 | 140 | 140 | 140 |
| suppression of | Margin voltage [V] | 22 | 22 | 18 | 22 |
| white spots | Determination | B | B | B | B |
| Photosensitive member contamination | | A | B | A | A |
| Charging roller | 1K | A | A | A | A |
| contamination | 10K | A | A | A | A |

| | | | | |
|---|---|---|---|---|
| Overall evaluation | A | B | A | A |

Table 16 is as follows.

TABLE 16

| No. | | 14 | 15 | 16 | 17 |
|---|---|---|---|---|---|
| Manufacturing | Appropriate voltage [V] | 120 | 120 | 120 | 120 |
| method for | Generation voltage [V] | 140 | 140 | 160 | 120 |
| suppression of | Margin voltage [V] | 20 | 20 | 40 | 0 |
| white spots | Determination | B | B | A | D |
| Photosensitive member contamination | | A | A | A | A |
| Charging roller | 1K | A | A | A | A |
| contamination | 10K | A | A | A | A |

| | | | | |
|---|---|---|---|---|
| Overall evaluation | A | A | A | C |

Table 17 is as follows.

TABLE 17

| No. | | 18 | 19 | 20 | 21 |
|---|---|---|---|---|---|
| Manufacturing | Appropriate voltage [V] | 120 | 120 | 120 | 116 |
| method for | Generation voltage [V] | 140 | 140 | 140 | 140 |
| suppression of | Margin voltage [V] | 20 | 20 | 20 | 24 |
| white spots | Determination | B | B | B | B |
| Photosensitive member contamination | | A | A | A | B |
| Charging roller | 1K | A | A | A | A |
| contamination | 10K | A | A | A | A |

| | | | | |
|---|---|---|---|---|
| Overall evaluation | A | A | A | B |

As shown in Tables 1 to 17, the image forming apparatuses Nos. 1, 4, 7 to 16 and 18 to 21 included the two-component developer including a carrier and a toner, the photosensitive member, a charging device which charged the surface of the photosensitive member, a development device which supplied the toner to the surface of the photosensitive member and developed the toner as the toner image and the intermediate transfer belt to which the toner image was intermediately transferred. The intermediate transfer belt contained a base resin and a conductive agent. The base resin included a thermoplastic resin or a thermosetting resin. The photosensitive member included a base member and an amorphous silicon photosensitive layer. The arithmetic average roughness Ra of the surface of the photosensitive member was equal to or greater than 37 nm but equal to or less than 105 nm. The carrier included the carrier particle. The toner included toner particle. The toner particle included a toner base particle and a toner external additive adhered to the surface of the toner base particle. The toner external additive included a spacer particle. The number average primary particle diameter of the spacer particle was greater than the arithmetic average roughness Ra of the surface of the photosensitive member. Consequently, the image forming apparatuses Nos. 1, 4, 7 to 16 and 18 to 21 were able to suppress the generation of white spots and the contamination of the charging device and the photosensitive member.

On the other hand, in the image forming apparatuses Nos. 2, 6 and 17, the number average primary particle diameter of the spacer particle was smaller than the arithmetic average roughness Ra of the surface of the photosensitive member. Hence, in the image forming apparatuses Nos. 2, 6 and 17, it is determined that the adhesion of the toner particle and the photosensitive member was not able to be sufficiently reduced. Consequently, in the image forming apparatuses Nos. 2, 6 and 17, the generation of white spots was not able to be suppressed.

In the image forming apparatus No. 3, the Ra of the photosensitive member was excessively great. Hence, it is determined that in the image forming apparatus No. 3, a gap between the photosensitive member and a cleaning blade was easily generated, and thus the toner external additive adhered to the photosensitive member was not able to be sufficiently cleaned. Consequently, in the image forming apparatus No. 3, the occurrence of the contamination of the charging device was not able to be suppressed.

In the image forming apparatus No. 4, the Ra of the photosensitive member was excessively small. Hence, it is determined that in the image forming apparatus No. 4, the cleaning blade wore as it was used, and thus the toner external additive adhered to the photosensitive member was not able to be sufficiently cleaned. Consequently, in the image forming apparatus No. 4, the occurrence of the contamination of the charging device was not able to be suppressed.

In the image forming apparatus of the present disclosure, it is possible to suppress the generation of white spots and the contamination of the charging device and the photosensitive member.

The image forming apparatus of the present disclosure can be used in order to form images in, for example, a copying machine, a printer or a multifunctional peripheral.

What is claimed is:

1. An image forming apparatus comprising:
a two-component developer that includes a carrier and a toner;
a photosensitive member;
a charging device that charges a surface of the photosensitive member;
a development device that supplies the toner to the surface of the photosensitive member and develops the toner as a toner image; and
an intermediate transfer belt to which the toner image is intermediately transferred,
wherein the intermediate transfer belt contains a base resin and a conductive agent,
the base resin includes a thermoplastic resin or a thermosetting resin,
the photosensitive member includes a base member and an amorphous silicon photosensitive layer,
an arithmetic average roughness Ra of the surface of the photosensitive member is equal to or greater than 37 nm but equal to or less than 105 nm,
the carrier includes a carrier particle,
the toner includes a toner particle;
the toner particle includes a toner base particle and a toner external additive that is adhered to a surface of the toner base particle,
the toner external additive includes a spacer particle and
a number average primary particle diameter of the spacer particle is greater than the arithmetic average roughness Ra of the surface of the photosensitive member.

2. The image forming apparatus according to claim 1,
wherein a coverage ratio of the spacer particle in the toner particle is equal to or greater than 7% by area and equal to or less than 45% by area.

3. The image forming apparatus according to claim 1,
wherein the spacer particle includes a resin particle.

4. The image forming apparatus according to claim 1,
wherein the spacer particle includes a silica particle.

5. The image forming apparatus according to claim 1,
wherein the number average primary particle diameter of the spacer particle is equal to or greater than 45 nm and equal to or less than 140 nm.

6. The image forming apparatus according to claim 1,
wherein the carrier particle includes a carrier base particle and a carrier external additive that is adhered to a surface of the carrier base particle, and
a number average primary particle diameter of the carrier external particle is less than the arithmetic average roughness Ra of the surface of the photosensitive member.

7. The image forming apparatus according to claim 6,
wherein a coverage ratio of the carrier external additive in the carrier particle is equal to or greater than 5.0% by area and equal to or less than 35% by area.

8. The image forming apparatus according to claim 6,
wherein the carrier external additive includes a strontium titanate particle.

9. The image forming apparatus according to claim 6,
wherein the number average primary particle diameter of the carrier external particle is equal to or greater than 15 nm and equal to or less than 85 nm.

10. The image forming apparatus according to claim 1,
wherein the base member includes a roughened surface, and
the roughened surface has been subjected to blasting treatment.
